(19) United States
(12) Patent Application Publication
(10) Pub. No.: US 2006/0050123 A1
(43) Pub. Date: Mar. 9, 2006

(54) Image recording device and image recording method, and image receiving layer transferer element and image forming medium using them

(76) Inventors: Toshiyuki Wada, Minoo (JP); Akihiro Imai, Ikoma (JP); Yoshihiro Yokoyama, Takatsuki (JP)

Correspondence Address: WENDEROTH, LIND & PONACK, L.L.P., 2033 K STREET N. W., SUITE 800, WASHINGTON, DC, 20006-1021, US

(21) Appl. No.: 10/522,127

(22) PCT Filed: Jul. 24, 2003
(86) PCT No.: PCT/JP03/09369

§ 371 Date: Jan. 24, 2005

(30) Foreign Application Priority Data
Jul. 25, 2002 (JP) 2002-216891

(51) Int. Cl. B41J 2/01

(52) U.S. Cl. 347/103

(57) ABSTRACT

In an apparatus for forming an image on an image receiver, in order to solve at least one problem that an ink sheet may be attached to an image receiving layer in a thermal transfer recording and that the image receiving layer may be transferred to an image receiver insufficiently in an image recording using an ink-jet head, there is provided an image recording apparatus comprising: an image forming medium which extends over at least one platen and comprises an image receiving layer, an image recording section having at least one ink-jet head which faces the image receiving layer of the image forming medium on an outer periphery of one platen of said at least one platen, and an image transfer section having an image receiver and an image transfer heat medium which faces the image forming medium in its back side, wherein the image forming medium comprises a laminate of an aqueous solvent permeating layer and the image receiving layer which are laminated on and in the above listed order from a substrate for the image forming medium.

### TECHNICAL FIELD

The present invention relates to an image recording apparatus and an image recording method with an indirect recording means such as an ink-jet head and a toner-jet head etc., and an image receiving layer transferer and an image forming support used for them.

### BACKGROUND ART

An image recording method, wherein first an image is recorded in an image receiving layer and then the image receiving layer in which the image is recorded is transferred to an image receiver, is known as a recording method in which an image is recorded on an arbitrary substrate such as a paper (hereinafter “image receiver” (or “image receiving element”)). Such recording method contains, for example two kinds of recording methods as follows.

First recording method comprises of transferring an image receiving layer of an image receiving transferer to an intermediate support temporarily, wherein after recording an image in the image receiving layer transferred to the intermediate support by using a heat melt type or a sublimation type (or a dye diffusion type) thermal transfer recording method, the image receiving layer in which the image is recorded is re-transferred from the intermediate support to the image receiver so that the image is recorded (or formed) on the image receiver (see for example JP-A-04-156384). Hereinafter, this method is referred to as a recording method using an intermediate support.

Second recording method comprises of using an image forming medium with an image receiving layer in place of the above intermediate support, wherein after recording an image in the image receiving layer of the image forming medium by using an ink-jet recording method, the image receiving layer in which the image is recorded is thermally transferred from the image forming medium to the image receiver so that the image is recorded on the image receiver (see for example JP-A-58-222877). Hereinafter, this method is referred to as a recording method using an image forming medium.

In the first recording method, the image receiving layer which is transferred to the intermediate support should be finally re-transferred to the image receiver. Therefore, the image receiving layer on the intermediate support is held mildly, a dye layer of an ink-sheet of the thermal transfer recording method is directly contacted with the image receiving layer on the intermediate record medium, and the image is recorded by heating and pressing with a heating head. Therefore, there is a problem that the image receiving layer and the dye layer melt and adhere each other, that is, a problem that a so-called “trapping” phenomenon may be caused wherein the image receiving layer adheres to the dye layer of the ink-sheet and transfers to the ink-sheet.

Moreover, in the first recording method, when the image receiving layer in which the image is recorded is thermally transferred from the intermediate support to the image receiver, the image receiving layer on the intermediate support is transferred to the image receiver by heating the intermediate support from the opposite surface (that is, its back surface) of the intermediate support to which the image receiving layer adheres. Furthermore, this transfer is usually carried out by pressing and heating the intermediate support on the image receiver while moving the intermediate support and the image receiver and inserting them between a platen (a roller or a drum) and a heat medium.

When for example a thermal head is used as the heat medium and for example a polymer film is used as the intermediate support, there are problems that a “sticking” phenomenon may be caused by a frictional resistance so that the image receiving layer may be transferred insufficiently, and that waste powder (or friction powder) of the polymer film may be produced by the friction so that the powder may deposit on the thermal head.

Therefore, a coating film (or a resin layer) is formed on the polymer film in order to improve various properties such as abrasion resistance and heat resistance etc. of the polymer film which is used for the intermediate support. However, similarly there is a problem that the sticking phenomenon is caused by the frictional resistance between the thermal head and the polymer film, and further, waste powder of the formed coating film is produced so that the powder may be deposited on the thermal head. Further, when the coating film of the polymer film has insufficient flatness and the coating film has some defects, there is a problem that an image formed on the image receiver may be reflect the flatness and the defects of the coating film of the polymer film on occasion of transferring the image receiving layer of the intermediate support to the image receiver.

When a shape of the intermediate support is like an endless-belt, and when the shape of the intermediate support is like a belt comprising a rewinding part and a winding part for the intermediate support and the intermediate support is used repeatedly by rewinding and winding it, that is, when the intermediate support repeatedly runs many times and the same portion of the intermediate support contacts with the heat medium repeatedly, the heat resistance and the abrasion resistance of the intermediate support may be more problematic, so that the problem that waste powder of the intermediate support may be produced and the waste powder may be deposited on the heat medium (or the heat body) may be more notable.

In keeping the heat medium used on condition that the waste powder of the intermediate support is attached to and deposited on the heat medium, a phenomenon may be caused wherein a part of the heat medium is covered by the waste powder or deteriorated so that the part of the heat medium may not produce heat. When the part of the heat medium may not produce heat, a part of the image receiving layer of the intermediate support which corresponds to such part of the heat medium is not transferred to the image receiver on occasion that the image receiving layer on the intermediate record layer is transferred to the image receiver. Therefore, a problem that an intended image cannot be formed on the image receiver may occur.

Furthermore, when the endless-belt like intermediate support is used and the endless-belt has the coating film, a problem is how to produce the endless-belt with a uniform coating film.

Further, in the second record method, there is a problem that the image receiving layer may be transferred to the image receiver insufficiently. Since this problem may occur when the image is recorded in the image receiving layer by using an ink-jet head, this problem seems to be more associated with use of the ink-jet head.

### DISCLOSURE OF INVENTION

Problems to be Solved by the Present Invention

The present invention has completed in order to solve those problems. An object of the present invention is to provide a novel image recording apparatus for image recording and a novel image recording method which solve a problem that a “trapping” phenomenon may occur wherein the image receiving layer adheres to the dye layer of the ink-sheet which is used for recording the image in the image receiving layer and for thermal transfer recording. Further, the object of the present invention is to provide the novel image recording apparatus for image recording and the novel image recording method which alleviate or substantially solve at least one of problems that frictional resistance between the intermediate support and the thermal head is large, abrasion resistance and heat resistance of the intermediate support are insufficient, flatness and durability of the coating film formed on the intermediate support are insufficient and it is not easy to form the intermediate support in a shape of an endless belt when the recording method using the intermediate support is carried out, and the image receiving layer may be insufficiently transferred to the image receiver when the image is recorded on the image receiving layer by using the ink-jet head. The image recording method of the present invention is preferably carried out by using the image recording apparatus of the present invention.

Means for Solving the Problems

The present inventors have extensively researched so as to solve the foregoing problems, and finally discovered that the problems can be solved or alleviated by using an ink-jet head or a toner-jet head in place of the thermal head which is used in recording the image, and by using a specific structure for a structure of the intermediate support and by using a specific method for manufacturing the intermediate support with respect to the image recording apparatus and image recording method, and further by reducing an influence of a liquid component contained in an ink since it is find out that this liquid component affects image recording whenever the ink-jet head is used in any cases that the intermediate support is used and that the image forming medium is used.

The present invention provides an image recording apparatus and an image recording method commonly using an ink-jet head or a toner-jet head in recording an image as mentioned above, wherein the image recording apparatus comprises an intermediate support and the image recording method uses the intermediate support, and the image recording apparatus comprises an image forming medium and the image recording method uses the image forming medium. Furthermore, the present invention provides an image receiving layer transferer and an image forming medium which are used in the mentioned apparatus and method.

In one gist of the present invention, a novel image recording apparatus is provided. It is an image recording apparatus comprising an intermediate support, the image recording apparatus comprising:
the intermediate support which forms a closed loop and extends over at least one platen, an image receiving layer transfer section having
an image receiving layer transferer which includes an image receiving layer and
an image receiving layer transfer head which faces a part of the intermediate support on an outer periphery of one platen of said at least one platen,
an image recording section having at least one ink-jet head or toner-jet head which faces to a part of the intermediate support on an outer periphery of one platen which is the same as or different from said one platen, and
an image transfer section having
   an image receiver and
   an image transfer heat medium which faces the intermediate support inside the closed loop,
wherein the intermediate support comprises a substrate and a coating film, and
the coating film is formed by applying a coating composition for forming the coating film on at least one main surface of the substrate by using a spraying method.

Moreover, in respect to the above mentioned image recording apparatus, an image recording apparatus is provided according to the present invention,
wherein the intermediate support comprises a substrate and a coating film, and
the coating film is formed by applying a coating composition for forming the coating film on at least one main surface of the substrate and then baking it at a temperature of not lower than 140° C. for a time of not shorter than 10 minutes, in place of the intermediate support of the above mentioned image recording apparatus.

Furthermore, in one embodiment of the above image recording apparatus according to the present invention, an image recording apparatus is preferable,
wherein the coating film of the intermediate support is formed on its back surface and the coating film contains a fluoro-resin (or a fluoropolymer) as a solid lubricant.

In another gist of the present invention, a novel image recording apparatus is provided. It is the image recording apparatus comprising an intermediate support,
the image recording apparatus comprising:
the intermediate support which forms a closed loop and extends over at least one platen,
an image receiving layer transfer section having
   an image receiving layer transferer which includes an image receiving layer and
   an image receiving layer transfer head which faces a part of the intermediate support on an outer periphery of one platen of said at least one platen,
an image recording section having at least one ink-jet head which faces to a part of the intermediate support on an outer periphery of one platen which is the same as said one platen, and
an image transfer section having
   an image receiver and
   an image transfer heat medium which faces the intermediate support inside the closed loop,
wherein the platen on which the image receiving layer transfer section is positioned comprises a heat medium for heating the platen.

Furthermore, in another gist of the present invention, a novel image recording apparatus is provided. It is an image recording apparatus comprising an intermediate support, the image recording apparatus comprising:
the intermediate support which forms a closed loop and extends over at least one platen,
an image receiving layer transfer section having
   an image receiving layer transferer which includes an image receiving layer and
   an image receiving layer transfer head which faces a part of the intermediate support on an outer periphery of one platen of said at least one platen,
an image recording section having at least one ink-jet head which faces a part of the intermediate support on an outer periphery of one platen which is the same as or different from said one platen, and
an image transfer section having
   an image receiver and
   an image transfer heat medium which faces the intermediate support inside the closed loop,
wherein the image receiving layer transferer including the image receiving layer comprises a laminate of the image receiving layer and an aqueous solvent permeating layer which are laminated on and in the above listed order from a substrate for the image receiving layer transferee.

Further, in a preferable embodiment of the present invention, a novel image recording apparatus is provided. It is an image recording apparatus comprising an intermediate support, the image recording apparatus comprising:
the intermediate support which forms a closed loop and extends over at least one platen,
an image receiving layer transfer section having
   an image receiving layer transferer which includes an image receiving layer and
   an image receiving layer transfer head which faces a part of the intermediate support on an outer periphery of one platen of said at least one platen,
an image recording section having at least one ink-jet head which faces to a part of the intermediate support on an outer periphery of one platen which is the same as or different from said one platen, and
an image transfer section having
   an image receiver and
   an image transfer heat medium which faces the intermediate support inside the closed loop,
wherein the image recording section comprises an image drying mechanism which accelerates drying of an image recorded on the image receiving layer.

In addition, an image receiving layer transferer comprising a laminate in which an image receiving layer and an aqueous solvent permeating layer are laminated on a substrate for the image receiving layer transferer in the above listed order from the substrate is provided according to the present invention.

Moreover, in another gist of the present invention, a novel image recording apparatus is provided. It is an image recording apparatus comprising an image forming medium, the image recording apparatus comprising:
the image forming medium which extends over at least one platen and comprises an image receiving layer,
an image recording section having at least one ink-jet head which faces the image receiving layer of the image forming medium on an outer periphery of one platen of said at least one platen, and
an image transfer section having
   an image receiver and
   an image transfer heat medium which faces the image forming medium in its back side,
wherein the image forming medium comprises a laminate of an aqueous solvent permeating layer and the image receiving layer which are laminated on and in the above listed order from a substrate for the image forming medium.

Furthermore, in another gist of the present invention, a novel image recording apparatus is provided. It is an image recording apparatus comprising an image forming medium, the image recording apparatus comprising:
the image forming medium which extends over at least one platen and comprises an image receiving layer,
an image recording section having at least one ink-jet head which faces the image receiving layer of the image forming medium on an outer periphery of one platen of said at least one platen, and
an image transfer section having
   an image receiver and
   an image transfer heat medium which faces the image forming medium in its back side,
wherein the image recording section comprises an image drying mechanism which accelerates drying of an image recorded on the image receiving layer of the image forming medium.

Further, an image forming medium comprising a laminate wherein an aqueous solvent permeating layer and an image receiving layer are laminated on a substrate for the image forming medium in the above listed order from the substrate is provided according to the present invention.

In addition, in another gist of the present invention, a novel image recording apparatus is provided. It is an image recording apparatus comprising an image forming medium, the image recording apparatus comprising:
the image forming medium which extends over at least one platen and comprises an image receiving layer,
an image recording section having
   at least one ink-jet head which faces the image receiving layer of the image forming medium on an outer periphery of one platen of said at least one platen and
   an image drying mechanism which accelerates drying of an image recorded on the image receiving layer of the image forming medium, and
an image incorporating section having
   an image receiver and
   an image incorporating heat medium for integrating the image forming medium which includes the image receiver which faces the image forming medium in its back side.

Moreover, in one gist of the present invention, a novel image recording method is provided. It is an image recording method using an intermediate support, the image recording method using:
the intermediate support which forms a closed loop and while it extends over at least one platen,
an image receiving layer transferer comprising an image receiving layer,
an image receiving layer transfer head for thermally transferring the image receiving layer to the intermediate support,
at least one ink-jet head or toner-jet head for recording an image on the image receiving layer,
an image receiver, and
an image transfer heat medium for transferring the image receiving layer on which the image is recorded from the intermediate support to the image receiver,
wherein the image recording method comprises:
an image receiving layer transfer step in which the image receiving layer transferer is heated from its back surface, so that the image receiving layer is thermally transferred to the intermediate support in an image receiving layer transfer section,
an image recording step in which the image is recorded on the image receiving layer of the intermediate support by using the ink-jet head or toner-jet head, and the image receiving layer transfer head and said at least one ink-jet head or toner-jet head face a part of the intermediate support on an outer periphery of a platen which is the same as or different from the platen which they faces in an image recording section, and
an image transfer step in which the intermediate support is heated from its back surface by using the image transfer heat medium, so that the image receiving layer on which the image is recorded is transferred to the image receiver in an image transfer section,
the intermediate support comprises a substrate and a coating film, and
the coating film is formed by applying a coating composition for forming the coating film on at least one main surface of the substrate by using a spraying method.

Furthermore, in the above mentioned recording method using the intermediate support, an image recording method is provided according to the present invention, wherein
the image recording method comprises:
the intermediate support comprises a substrate and a coating film, and
the coating film is formed by applying a coating composition for forming the coating film on at least one main surface of the substrate and then baking it at a temperature of not lower than 140° C. for a time of not shorter than 10 minutes,
in place of the intermediate support used in the above mentioned recording method.

In the above mentioned image recording method using the intermediate support, the coating film of the intermediate support is preferably formed on its back surface and the coating film preferably contains a fluoro-resin as a solid lubricant.

Further, in another gist of the present invention, a novel image record method using an intermediate support is provided. It is an image recording method using:
the intermediate support which forms a closed loop while it extends over at least one platen,
an image receiving layer transferer comprising an image receiving layer,
an image receiving layer transfer head for thermally transferring the image receiving layer to the intermediate support,
at least one ink-jet head for recording an image on the image receiving layer,
an image receiver, and
an image transfer heat medium for transferring the image receiving layer on which the image is recorded from the intermediate support to the image receiver,
wherein the image recording method comprises:
an image receiving layer transfer step in which the image receiving layer transferer is heated from its back surface, so that the image receiving layer is thermally transferred to the intermediate support in an image receiving layer transfer section,
an image recording step in which the image is recorded in the image receiving layer of the intermediate support by using the ink-jet head, and the image receiving layer transfer head and said at least one ink-jet head face a part of the intermediate support on an outer periphery of a platen which is the same as the platen which they face in an image recording section, and
an image transfer step in which the intermediate support is heated from its back surface by using the image transfer heat medium, and the image receiving layer on which the image is recorded is transferred to the image receiver in an image transfer section, and
the platen on which the image receiving layer transfer section is positioned comprises a heat medium for heating the platen.

Moreover, in another gist of the present invention, a novel image recording apparatus comprising an intermediate support is provided. It is the image recording method using:
the intermediate support which forms a closed loop while it extends over at least one platen,
an image receiving layer transferer comprising an image receiving layer,
an image receiving layer transfer head for thermally transferring the image receiving layer to the intermediate support,
at least one ink-jet head for recording an image on the image receiving layer,
an image receiver, and
an image transfer heat medium for transferring the image receiving layer on which the image is recorded from the intermediate support to the image receiver,
wherein the image receiving layer transferer which comprises the image receiving layer comprises a laminate in which the image receiving layer and an aqueous solvent permeating layer are laminated on and in the above listed order from a substrate for the image receiving layer transferee, and
the image recording method comprises:
an image receiving layer transfer step in which the image receiving layer transferer is heated from its back surface, so that the image receiving layer is thermally transferred to the intermediate support in an image receiving layer transfer section,
an image recording step in which the image is recorded on the image receiving layer of the intermediate support by using the ink-jet head, and the image receiving layer transfer head and said at least one ink-jet head face a part of the intermediate support on an outer periphery of a platen which is the same as or different from the platen which they face in an image recording section, and
an image transfer step in which the intermediate support is heated from its back surface by using the image transfer heat medium, so that the laminate which has the image recorded is transferred to the image receiver in an image transfer section.

Furthermore, in another preferable gist of the present invention, a novel image recording method using an intermediate support is provided. It is an image recording method using:
the intermediate support which forms a closed loop while it extends over at least one platen,
an image receiving layer transferer comprising an image receiving layer,
an image receiving layer transfer head for thermally transferring the image receiving layer to the intermediate support,
at least one ink-jet head for recording an image on the image receiving layer,
an image receiver, and
an image transfer heat medium for transferring the image receiving layer on which the image is recorded from the intermediate support to the image receiver, wherein
the image recording method comprises:
an image receiving layer transfer step in which the image receiving layer transferer is heated from its back surface, so that the image receiving layer is thermally transferred to the intermediate support in an image receiving layer transfer section,
an image recording step in which the image is recorded in the image receiving layer of the intermediate support by using the ink-jet head, and the image receiving layer transfer head and said at least one ink-jet head face a part of the intermediate support on an outer periphery of a platen which is the same as or different from the platen to which they face in an image recording section, and
an image transfer step in which the intermediate support is heated from its back surface by using the image transfer heat medium, so that the image receiving layer on which the image is recorded is transferred to the image receiver in an image transfer section, and the image recording section comprises an image drying mechanism which accelerates drying of the recorded image on the image receiving layer.

Moreover, in another gist of the present invention, a novel image recording method using an image forming medium is provided. It is an image recording method using:
the image forming medium which extends over at least one platen and comprises a laminate in which an aqueous solvent permeating layer and an image receiving layer are laminated on and in the above listed order from a substrate for the image forming medium,
an ink-jet head for recording an image on the image receiving layer,
an image receiver, and
an image transfer heat medium for thermally transferring the laminate in which the image is recorded on the image receiving layer from the image forming medium to the image receiver,
wherein the image recording method comprises:
an image recording step in which the image is recorded on the image receiving layer of the laminate on the image forming medium by using the ink-jet head in an image recording section, and
an image transfer step in which the image forming medium is heated from its back surface by using the image transfer heat medium and then the laminate in which the image is recorded is transferred to the image receiver in an image transfer section.

Furthermore, in another gist of the present invention, a novel image recording method using an image forming medium is provided. It is the image recording method using:
the image forming medium which extends over at least one platen and comprises an image receiving layer,
an ink-jet head for recording an image on the image receiving layer,
an image receiver, and
an image transfer heat medium for thermally transferring the image receiving layer on which an image is recorded from the image forming medium to the image receiver,
wherein the image recording method comprises:
an image recording step in which the image is recorded on the image receiving layer of the image forming medium by using the ink-jet head and an image drying step in which drying of the recorded image on the image receiving layer is accelerated in an image recording section, and
an image transfer step in which the image forming medium is heated from its back surface by using the image transfer heat medium and then the image receiving layer having the image recorded thereon is transferred to the image receiver in an image transfer section.

Further, in another gist of the present invention, a novel image recording method using an image forming medium is provided. It is an image recording method using:
the image forming medium which extends over at least one platen and comprises an image receiving layer,
an ink-jet head for recording an image on the image receiving layer,
an image receiver, and
an image incorporating heat medium for integrating the image receiver with the image forming medium in which an image is recorded on the image receiving layer,
wherein the image recording method comprises:
an image recording step in which the image is recorded on the image receiving layer of the image forming medium using the ink-jet head and an image drying step in which drying of the recorded image of the image receiving layer is accelerated in an image recording section, and
an image incorporating step in which the image forming medium is heated from its back surface by using the image incorporating heat medium, so that the image forming medium comprising the image receiving layer on which the image is recorded is integrated with the image receiver in an image incorporating section.

Effects of the Invention

Since the image is recorded by using the ink-jet head or toner-jet head, the image recording apparatus and the image recording method of the present invention can substantially solve or alleviate the problem that the “trapping” phenomenon may be caused wherein the image receiving layer adheres to the ink-sheet which is used in the thermal recording so as to record the image in the image receiving layer.

Since the intermediate support which is manufactured by the specific manufacturing method is used, the image recording apparatus and the image recording method according to the present invention can substantially solve or alleviate the problems that the frictional resistance between the intermediate support and the thermal head is large, the abrasion resistance and the heat resistance of the intermediate support are insufficient, the flatness and the durability of the coating film formed on the intermediate support are insufficient and it is not easy to form the intermediate support in the form of the endless-belt when the recording method comprising the intermediate support is carried out.

Further, in respect to the image recording apparatus and the image recording method according to the present invention, since it is find out that insufficient drying of the image affects the recording of the image when the image is recorded on the image receiving layer by using the ink-jet head, the inventors have extensively researched how to remove the liquid component. The problem that the image receiving layer may be insufficiently transferred to the image receiver is substantially solved or alleviated by using means such as forced drying of the image by the image drying mechanism after recording the image and providing the aqueous solvent permeating layer which is adjacent to the image receiving layer and absorbs the liquid component of the image.

### BRIEF DESCRIPTION OF THE DRAWINGS

FIG. 1 shows a schematic illustration of an embodiment of an image recording apparatus comprising an intermediate support according to the present invention;

FIG. 2 shows a schematic illustration of another embodiment of an image recording apparatus comprising an intermediate support according to the present invention;

FIG. 3 shows a schematic illustration of another embodiment of an image recording apparatus comprising an intermediate support according to the present invention;

FIG. 4 shows cross-sectional views of various embodiments of image receiving layer transferers comprising an image receiving layer along a direction perpendicular to a longitudinal direction;

FIG. 5 shows a cross-sectional view of an intermediate support along a direction perpendicular to a longitudinal direction;

FIG. 6 shows a cross-sectional view of an endless-belt like intermediate support along a direction parallel to a longitudinal direction.

FIG. 7 shows a schematic illustration of an image receiving layer transferer comprising a laminate of an image receiving layer and an aqueous solvent permeating layer which are laminated on and in this order from a substrate for the image receiving layer transferee.

FIG. 8 shows a schematic illustration of one embodiment of an image recording apparatus comprising an intermediate support according to the present invention and an image drying mechanism.

FIG. 9 shows a schematic illustration of another embodiment of an image recording apparatus comprising an intermediate support according to the present invention and furthermore an image drying mechanism.

FIG. 10 shows a schematic illustration of one embodiment of an image recording apparatus comprising an image forming medium according to the present invention.

FIG. 11 shows a schematic illustration of another embodiment of an image recording apparatus comprising an image forming medium according to the present invention.

FIG. 12 shows a schematic illustration of one embodiment of an image recording apparatus comprising an image forming medium according to the present invention and furthermore an image drying mechanism.

FIG. 13 shows a cross-sectional view of an image forming medium comprising an image receiving layer along a direction perpendicular to a longitudinal direction.

FIG. 14 shows a cross-sectional view of an image forming medium comprising a laminate along a direction perpendicular to a longitudinal direction wherein an aqueous solvent permeating layer and an image receiving layer are laminated on and in this listed order from a substrate for the image forming medium.

FIG. 15 shows a schematic illustration of one embodiment of an image recording apparatus comprising an image forming medium according to the present invention and an image incorporating section for integrating the image forming medium with an image receiver.

FIG. 16 shows a schematic illustration of a preferable image transfer section of an image recording apparatus comprising an image forming medium according to the present invention.

### DESCRIPTION OF REFERENCE NUMBERS IN THE DRAWINGS

100=an image receiving layer transfer section, 110=a rewinding roll for an image receiving layer transferee, 120=an image receiving layer transferee, 121=a substrate for an image receiving layer transferee, 122=an image receiving layer, 123=a heat-resistant sliding layer, 124=a releasing layer, 125=an aqueous solvent permeating layer, 130=an image receiving layer transfer head, 140=a winding roll for an image receiving layer transferer, 150=a platen, 200=an image recording section, 210=an ink-jet head for yellow (Y), 212=a platen, 214=an image drying mechanism, 220=an ink-jet head for magenta (M), 222=a platen, 224=an image drying mechanism, 230=an ink-jet head for cyan (C), 232=a platen, 234=an image drying mechanism, 240=an ink-jet head for black (B), 242=a platen, 244=an image drying mechanism, 250=an image drying mechanism, 300=an image transfer section, 310=a rewinding roll for an image receiver, 320=an image receiver, 330=a platen, 340=an image transfer heat medium, 350=a roller, 360=a roller, 370=a cutter, 380=a tray, 410=an intermediate support, 411=a substrate for an intermediate support, 412=a coating film, 413=a holding layer, 414=a connected part, 415=a tension adjusting roller, 420=a platen, 430=a platen, 510=an image forming medium, 511=a substrate for an image forming medium, 512=an image receiving layer, 513=a heat-resistant sliding layer, 514=a releasing layer, 515=an aqueous solvent permeating layer, 520=a rewinding roll for an image forming medium, 530=a winding roll for an image forming medium, 5-50=an image forming medium, 560=a rewinding roll for an image forming medium, 600=an image recording section, 610=an ink-jet head for yellow (Y), 612=a platen, 620=an ink-jet head for magenta (M), 622=a platen, 630=an ink-jet head for cyan (C), 632=a platen, 640=an ink-jet head for black (B), 642=a platen, 650=a platen, 660=an image drying mechanism, 700=an image transfer section, 710=a rewinding roll for an image receiver, 720=an image receiver, 730=a platen, 740=an image transfer heat medium, 750=a roller, 760=a roller, 770=a cutter, 780=a tray, 800=an image incorporating section, 810=a rewinding roll for an image receiver, 820=an image receiver, 830=a roller (or a rubber coating roller), 840=an image incorporating heat medium, 850=a cutter, 860=a tray, 910=an image forming support, 920=a rewinding roll for an image forming medium, 930=an ink-jet head, 940=an image transfer heat medium, 950=a platen, 960=an image receiver, 970=a winding roll for an image forming medium, 980=a cutter.

### DETAILED DESCRIPTION OF THE PREFERRED EMBODIMENTS

The image recording apparatus and the image recording method, and the image receiving layer transferer and the image forming medium (which comprise the image receiving layer) according to the present invention will be explained hereinafter with reference to the accompanying drawings.

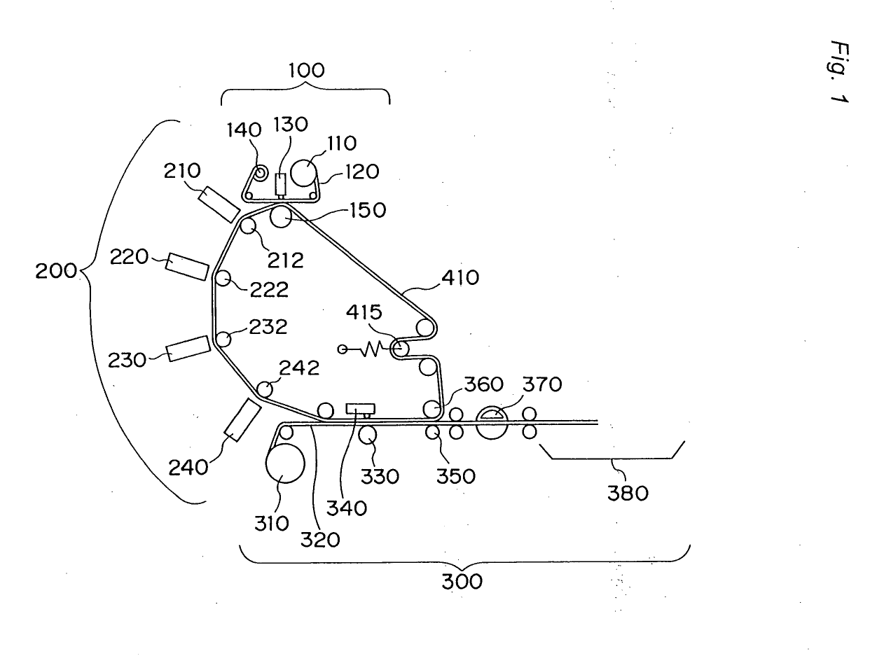

FIG. 1 shows a schematic illustration of one embodiment of the image recording apparatus according to the present invention. This is an image recording apparatus comprising an intermediate support wherein an image receiving layer transfer section 100, an image recording section 200 and an image transfer section 300 are placed in said order along an intermediate support 410 counterclockwise. The image receiving layer transfer section 100 comprises a rewinding roll 110 for an image receiving layer transferer an image receiving layer transferer 120, an image receiving layer transfer head 130, a winding roll 140 for an image receiving layer transferee, and a platen 150. The image recording section 200 comprises ink-jet heads (or toner-jet heads) for three primary colors (for yellow (Y), magenta (M) and cyan (C)) and for black (for black (B)) 210, 220, 230 and 240, and platens 212, 222, 232 and 242. The image transfer section 300 comprises a rewinding roll 310 for an image receiver, an image receiver 320, a platen 330, an image transfer heat medium 340, rollers 350 and 360, a cutter 370 and a tray 380. The intermediate support 410 extends over the platens 150, 212, 222, 232, 242 and the roller 360 etc., forms a closed loop and rotates counterclockwise. The image recording apparatus demonstrated in FIG. 1 further comprises a tension adjusting roller 415 since the intermediate support 410 is preferably provided with an appropriate tension.

A thermal head and a ceramic heater are exemplified as the image receiving layer transfer head 130. The image receiving layer transfer head 130 is preferably the thermal head and is positioned while facing the intermediate support 410.

The thermal head, a heat roller, the ceramic heater, a heat blower, an induction heating apparatus (or IH heater) etc. are exemplified as the image transfer heat medium 340. The image transfer heat medium 340 is preferably the thermal head. The image transfer heat medium 340 is also preferably the IH heater. Since the IH heater makes it possible to start heating rapidly and has a small heat capacity, use of the IH heater provides an advantage in that an only portion to be heated can be heated momentarily by less heat. Moreover, the IH heater also has an advantage in that the IH heater which is cheaper and simpler than the thermal head can be manufactured.

In the image recording apparatus shown in FIG. 1, it is possible to carry out a full-color recording since the ink-jet heads 210, 220, 230 and 240 are positioned. The ink-jet head 240 for B is not necessary so as to carry out the full-color recording, but the ink-jet head 240 for B is preferably positioned. When a black and white recording is carried out, the only ink-jet head 240 for B may be used. Each of the ink-jet heads 210, 220, 230 and 240 may be a toner-jet head.

There is no particular limitation on the ink-jet head so long as it is conventionally used and its use can provide an objective image according to the present invention. There is no particular limitation on the toner-jet head so long as it is conventionally used and its use can provide an objective image according to the present invention.

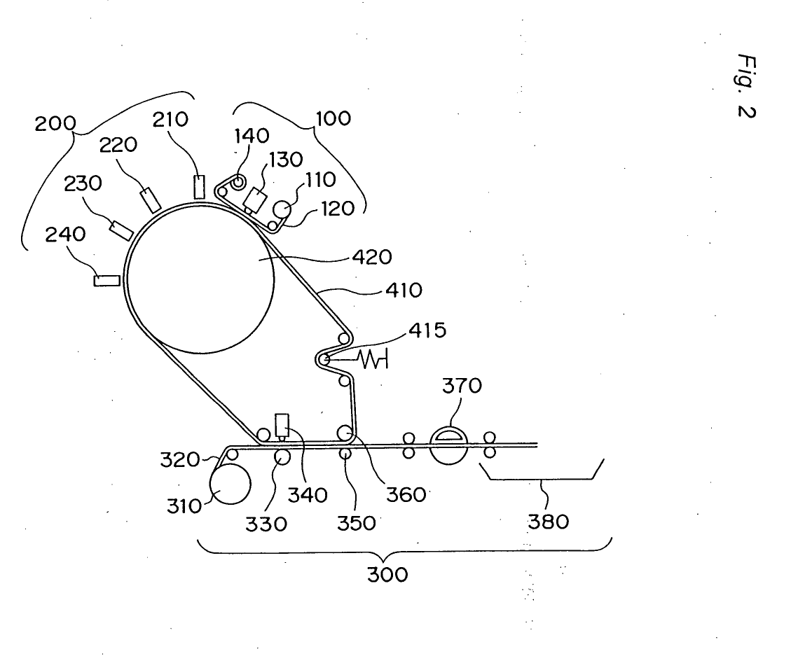

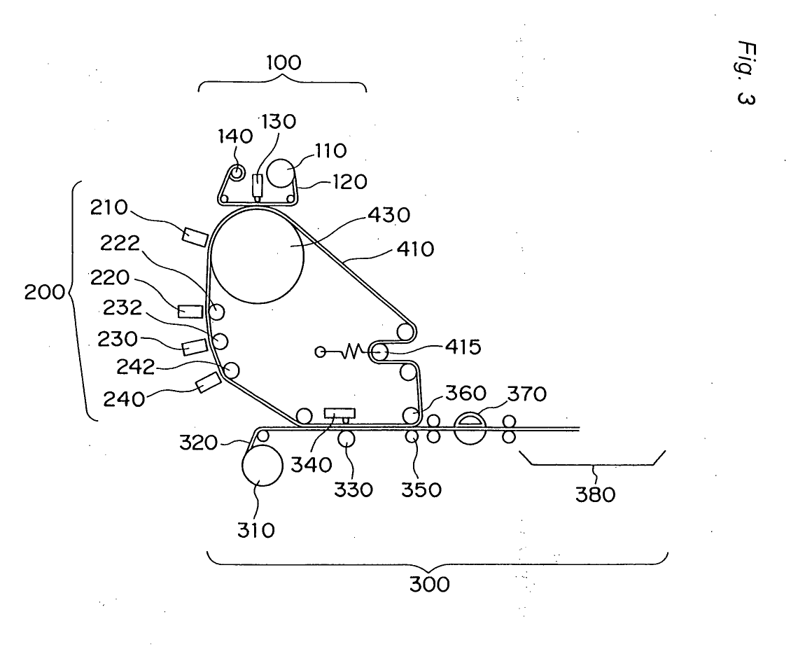

In the image recording apparatus shown in FIG. 1, each of the platens faces each of the image receiving layer transfer head 130 and the ink-jet heads 210, 220, 230 and 240, but all of the mentioned image receiving layer transfer head 130 and ink-jet heads 210, 220, 230 and 240 may be arranged while facing the only one platen 420 as demonstrated in an image recording apparatus shown in FIG. 2, and further the mentioned image receiving layer transfer head 130 and the ink-jet head 210 may be located while facing to the one platen 430 as demonstrated in an image recording apparatus shown in FIG. 3. Therefore, there is no particular limitation on the lay-out of the image receiving layer transfer head and the ink-jet heads to the platens in the image recording apparatus comprising the intermediate support according to the present invention. The image recording apparatus shown in FIGS. 2 and 3 are similar to the image recording apparatus shown in FIG. 1 except that the lay-outs of the image receiving layer transfer head and the ink-jet heads to the platens are different from that of the image recording apparatus shown in FIG. 1.

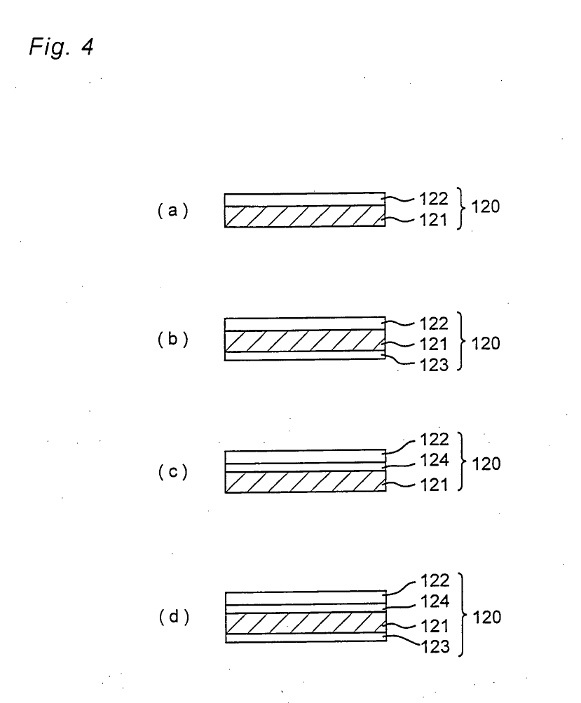

The image receiving layer transferer 120 comprises a substrate 121 for the image receiving layer transferer and an image receiving layer 122, which is shown in FIG. 4. FIGS. 4 (a)-(d) show cross-sectional views of various embodiments of the image receiving layer transferer 120 along a direction perpendicular to a longitudinal direction. The image receiving layer transferer shown in FIG. 4 (a) comprises the image receiving layer 122 on the substrate 121. The image receiving layer transferer shown in FIG. 4 (b) comprises the image receiving layer 122 on the substrate 121 and a heat-resistant sliding layer 123 under the substrate 121. The image receiving layer transferer shown in FIG. 4(c) comprises a releasing layer 124 between the substrate 121 and the image receiving layer 122 in the image receiving layer transferer shown in FIG. 4(a). The image receiving transferer shown in FIG. 4(d) further comprises the heat-resistant sliding layer 123 under the substrate 121 in the image receiving layer transferer shown in FIG. 4(c).

There is no particular limitation on the substrate 121 for the image receiving layer transferee, the heat-resistant sliding layer 123 and the releasing layer 124 so long as they are conventionally used in the image recording apparatus comprising the intermediate support. There is no particular limitation on the image receiving layer 122 so long as it is conventionally used for ink-jet recording when the ink-jet head is used in the image recording section. There is no particular limitation on the image receiving layer 122 so long as it is conventionally used for toner-jet recording when the toner-jet head is used in the image recording section.

Examples of the substrate 121 contains films of polyethylene terephthalate (PET), polyethylene naphthalate (PEN), aramid, triacetylcellulose, polyparabanic acid, polysulphone, polypropylene (PP), cellophane, water vapor-proofed cellophane, ultraviolet cure film and polyethylene etc.

The image receiving layer 122 may contain at least one of polymer materials as one component of its composition so long as it can provide an objective image according to the present invention. The image receiving layer 122 may have multi layered structure comprising two or more layers. Thermoplastic resins and thermoset resins are exemplified as the polymer materials which form the image receiving layer. Examples of the thermoplastic resins and the thermoset resins contain polyvinylchloride, vinylchloride-vinylacetate copolymer, a polyvinylacetal based resin, an urethane (or polyurethane) based resin, an acrylic based resin, an amide based resin, an ester based resin, a cellulosic based resin, an epoxy based resin, a phenol based resin, a phenoxy based resin, a silicone based resin, an alkyd based resin and a styrene based resin etc.

Examples of materials which form the releasing layer 124 contain an olefin based resin such as polyethylene, a silicone based resin, an acrylic silicone based resin and mixtures of these resins with a following releasing agent. Examples of the releasing agent contain a silicone, a modified silicone oil, a silicone resin, an acrylic silicone resin and a fluoro-resin (fluoro based resin, fluorine-containing resin) etc.

The image receiving layer transferer as shown in FIG. 4(c) in which the image receiving layer is formed on the substrate via the releasing layer is preferable. The image receiving layer transferer as shown in FIG. 4(b) in which the heat-resistant layer is formed under the substrate is preferable. Therefore, the image receiving layer transferer as shown in FIG. 4(d) in which the image receiving layer is formed on the substrate via the releasing layer and the heat-resistant sliding layer is formed on its back surface is more preferable.

There is no particular limitation on the image receiver 320 so long as its use can provide an objective image according to the present invention. Examples of the image receiver contain a paper, a coated paper-comprising a layer coated by a resin on its surface, a RC paper (resin coating paper), a photographic paper, a synthetic paper, a laminated paper of a cellulose paper with a synthetic paper (or a polymer sheet such as polyethylene, polypropylene, expanded PET, particulate-containing extruded sheet etc.). The image receiver 320 particularly preferably comprises the cellulose paper of which at least one main surface is laminated with a polyethylene. Since the polyethylene is soften easily by heat, when the image receiving layer is adhered to the image receiver by heat in the image transfer section, the polyethylene on the surface of the image receiver makes it possible for the image receiving layer to adhere to the image receiver by less heat energy. The RC paper (resin coating paper) and the photographic paper are also preferable for the image receiver 320.

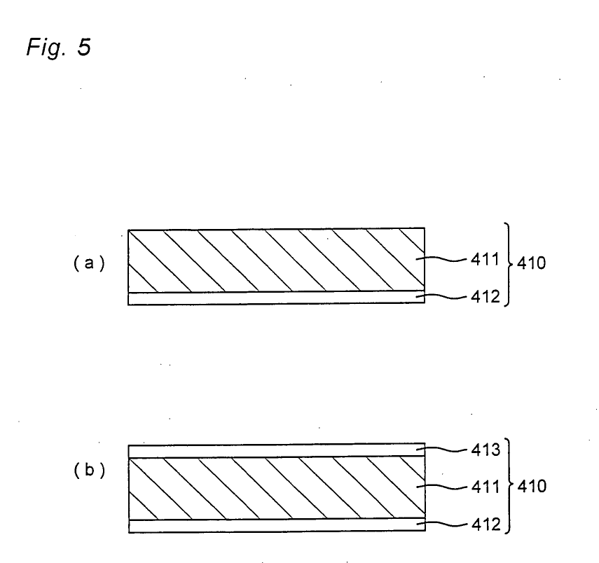

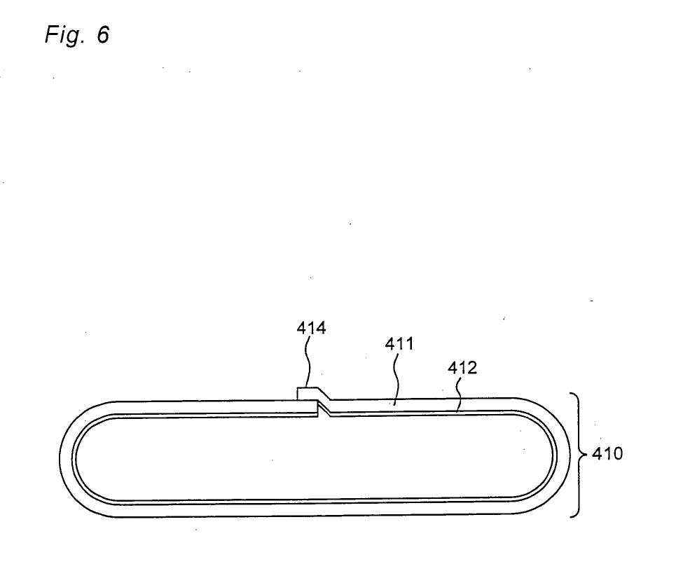

FIGS. 5 and 6 show cross-sectional views of preferable embodiments of the intermediate support 410 which is used in the image recording apparatus comprising the intermediate support according to the present invention. FIG. 5 shows a cross-sectional view along a direction perpendicular to a longitudinal direction of the intermediate support 410. FIG. 6 shows a cross-sectional view along a direction parallel to the longitudinal direction of the intermediate support 410. Each of the intermediate supports 410 comprises a coating film 412 on at least one surface of a substrate 411 for the intermediate support.

FIG. 5(a) shows the intermediate support 410 comprising the coating film 412 on one surface of the substrate 411. FIG. 5(b) shows the intermediate support 410 comprising the coating film 412 on one surface of the substrate 411 and a holding layer 413 on its opposite surface. FIG. 6 shows the intermediate support comprising the coating film 412 on an inner surface of the substrate 411 wherein the intermediate support is prepared by connecting both end portions of the elongated intermediate support (a connected part 414) and formed in a shape of an endless-belt. Therefore, the intermediate support is in a dorm of a connected endless-belt.

When the coating layer 412 and/or the holding layer 413 are/is formed, in view of improving an adhesive strength between the substrate 411 and the coating film 412 and/or the holding layer 413 and providing a uniform coating film and/or a uniform folding layer, the coating layer 412 and/or the holding layer 413 may be formed after previously providing a primer layer (not shown) on the substrate 411.

The coating film 412 is not preferably formed on a part of the connection surface of the connected part 414 shown in FIG. 6 so as to improve the adhesive strength, for example, when surfaces of the substrate are connected. Therefore, the substrate of the intermediate support is preferable wherein it is in the shape of the endless-belt having a seam and does not substantially comprise the coating film between the substrates of the connected part at the seam.

The connected part 414 may be prepared by bonding the substrate 411 to itself, for example by cold curing a thermoset adhesive at room temperature or by heat curing the adhesive at a temperature of not lower than 100° C. after attaching the substrate 411 to itself via the adhesive. An ultraviolet-curing adhesive (UV cure adhesive) may be used for the adhesive. The coating film 412 may be provided on an inner surface of the endless-belt and optionally the holding layer 413 may be provided on its outer surface.

A seamless endless-belt may be used for the substrate 411 for the intermediate support.

There is no particular limitation on a material constructing the substrate 411 for the intermediate support, but a thin polymer film is preferably used. A thickness of the substrate 411 is preferably in a range between 5 and 50 μm. Examples of the substrate 411 contains heat resistant films such as a polyimide based film, a polyamide based film, a polysulphone based film, a polyether based film, a polyparabanic acid based film and a polyester based film etc. At least one polymer film selected from the polyamide based polymer film and poyimide based polymer film is preferably used for the substrate for the intermediate support.

The substrate 411 for the intermediate support has particularly preferably thermal shrinkage of not more than 0.15% along each of directions both parallel (longitudinal direction) to and perpendicular (transverse direction) to the longitudinal direction of the substrate for the intermediate support when the substrate is maintained under an atmosphere of 200° C. for an hour. The thermal shrinkage is represented by the following equation (1):
Thermal shrinkage coefficient (% value)=100×[(length of the substrate before shrink)−(length of the substrate after shrink)]/(length of the substrate before shrink) (equation 1)

The coating film 412 can be formed by applying a coating composition (or liquid) for forming the coating film on the substrate 411 by means of printing methods such as gravure and various application methods using a wire bar, a gravure roll and a reverse roll etc. The coating film 412 is particularly preferably formed by applying it by means of a spraying method. The composition can be applied by using the spraying method so as to form the coating film having a thickness adjusted between 1 and 100 μm while the application being not so dependent on the form of the substrate 411. Therefore, a uniform coating film can be formed on the endless-belt like substrate 411 by using the spraying method.

When the intermediate support 410 is in the form of the endless-belt, the coating film may be formed before or after the substrate for the intermediate support is shaped in the form of the endless-belt. The coating composition can be recoated (or wet-on-wet coated) several times. That is, the coating composition can be applied several times so as to provide the coating film having an objective film thickness. Since the recoating can be carried out so as to compensate defects of the coating film which occur in applying the coating composition first, the coating film comprising overall less defects or substantially no defects can be formed. Since strength of the coating film is improved by recoating, the coating film having improved abrasion resistance can be obtained.

The coating composition can be applied without direct contact between the substrate 411 and a nozzle of a spray when the spraying method is carried out. When the connected part is formed by bonding the substrate surface to the substrate surface as shown in FIG. 6 (the adhesive between the substrates of the connected part is not shown in FIG. 6), so as not to form the coating film on one substrate of the connected part, the coating composition can be applied on the substrate of which the part is previously sealed. When a marker which is a part for detecting a position is provided on the intermediate support 410, the marker can be formed by using the coating film. Without forming the coating film by sealing the substrate, a part in which the coating film is not formed can be used for the marker. Therefore, use of the spraying method has an advantage in that the marker can be formed simultaneously together with the coating film.

The coating composition can be applied on the surface to be coated without changing properties of the surface on which the image receiving layer is transferred when the spraying method is used, since when the coating film is formed, an opposite surface of the surface on which the coating film is formed is protected by sealing periphery of the substrate such that the coating composition does not sneak around the opposite surface. Particularly when the surface to which the image receiving layer is transferred is polluted by a material having high releasability, such pollution makes it difficult for the image receiving layer to transfer to the intermediate support. It is important to protect the surface to which the image receiving layer is transferred.

Therefore, the image recording apparatus in which the intermediate support comprises the substrate and the coating film, and the coating film is formed by applying the composition for forming the coating film on at least one main surface of the substrate by using the spraying method is preferable.

The coating film 412 preferably contains various fluoro-polymer such as polytetrafluoroethylene, a perfluoroalkylvinyl ether based resin and a fluoro-copolymers as a solid lubricant. That is, the coating film for the intermediate support is preferably formed on a back surface of the intermediate support and preferably contains the fluoro-resin as the solid lubricant. Further, in the present specification, the back surface of the intermediate support is an opposite surface to a main surface of the intermediate support to which the image receiving layer is attached.

Moreover, the coating film preferably contains at least one selected from a polyimide based film, an amide based film, an epoxy based resin and a phenol based resin as a binder, more preferably contains at least one selected from the polyimide based resin and the epoxy based resin as the binder, and particularly preferably contains a thermoset resin. The coating film may contain an ultraviolet curing resin such as a polyimide based resin, an amide based resin, an epoxy based resin and a polyester based resin etc. The coating film may contain a thermoplastic resin in addition to the thermoset resin. The coating composition for forming the coating film is obtained by adding a solvent to the resin (or the resin mixture) for constituting the coating film comprising the above resin. Various organic solvents such as toluene, 2-butanone, ethanol, isopropyl alcohol, butanol, cyclohexanone, tetrahydrofuran, ethyl acetate, cellosolve acetate can be used as the solvent.

After formation of the coating film 412 on the substrate 411, the coating film is preferably subjected to a baking treatment at a temperature of not lower than 140° C. so as to improve a bonding strength between the coating film 412 and the substrate 411 of the intermediate support 410 and to enhance an abrasion strength on running the intermediate support. The coating film is preferably subjected to the backing treatment at a temperature of 140° C. for not shorter than ten minutes. The coating film is preferably subjected to the backing treatment at a temperature of 150° C. for not shorter than ten minutes and is more preferably subjected to the backing treatment at a temperature of 200° C. for not shorter than ten minutes when particularly the epoxy based resin and the polyimide based resin are used as the binder. The coating film may contain for example, a surface active agent, an antistatic agent and a lubricant etc.

Therefore, an image recording apparatus is preferable, in which the intermediate support comprises the substrate and the coating film which is formed by being subjected to the baking treatment at a temperature of not lower than 140° C. for not shorter than ten minutes after application of the coating composition for forming the coating film on at least one main surface of the substrate.

The holding layer 413 is formed so as to modify a surface which is one main surface of the substrate 411 of the intermediate support 410 and to which the image receiving layer is transferred. By providing the substrate 411 with the holding layer 413, an appropriate adhesive strength (or bond strength) between the substrate 411 and the image receiving layer can be obtained. The holding layer 413 preferably comprises a thermoset resin. The thremoset resin contains resins such as a polyimide based resin, an amide based resin, an epoxy based resin and polyester based resin etc. Furthermore, the holding layer 413 may contain an ultraviolet curing resin such as an epoxy based resin, a phenol based resin, a polyester based resin and a polyurethane based resin etc. Further, the holding layer 413 may contain a reactive group-containing resin such as a hydroxyl-containing resin etc. Similarly to the coating film 412, the holding layer 413 can be formed by various printing methods and application methods, and particularly preferably by the spraying method. In addition, a softening layer (not shown) giving the intermediate support plasticity may be provided between the substrate 411 and the holding layer 413.

Hereinafter, motions of the image recording apparatus comprising the intermediate support shown FIG. 1, and the image recording method using the intermediate support according to the present invention based on the motions will be explained. Furthermore, motions of image recording apparatus shown in FIGS. 2 and 3 and image recording methods based on the motions are similar to the motion of the image recording apparatus shown in FIG. 1 and to the image recording method based on the motions, except that differences based on the lay-out (or arrangement) of the image receiving layer transfer head, the ink-jet heads and the platens.

In the image receiving layer transfer section 100, the image receiving layer transferer 120 is provided between the image transfer head 130 and the intermediate support 410 from its rewinding roll 110, and pressed and heated by the image receiving layer transfer head 130. Subsequently, the image receiving layer transferer 120 is wound by its winding roll 140, and a defined image receiving layer only is left on the intermediate support 410. The intermediate support 410 rotates (or moves) counterclockwise, the image receiving layer is sent to the image recording section 200 by the intermediate support 410, and then an image receiving layer transfer step is completed.

In the image recording section 200, an image for yellow is recorded on the image receiving layer by the ink-jet head for Y 210. After each of images for M, C and B is recorded by each of the ink-jet heads for M, C and B 220, 230 and 240, the image receiving layer recorded is sent to the image transfer section 300 by the intermediate support 410, and then an image recording step is completed.

In the image transfer section 300, the image receiving layer on which the image is recorded is passed between the image transfer heat medium 340 and the platen while keeping the image receiving layer laid on the image receiver 320 and then transferred from the intermediate support 410 to the image receiver 320. The image receiver 320 comprising the transferred image receiving layer is optionally cut in the front and the rear of the image (furthermore, optionally on the right side and the left side of the image) by the cutter 370, the image which is cut is obtained in the tray 380, and an image transfer step is completed.

The intermediate support 410 which has finished the image recording in the image transfer section 360 returns to the image receiving layer transfer section 100 again. The above described steps are repeated. The above described steps can be carried out sequentially and continuously. The image receiving layer transfer head 130, the ink-jet heads for Y, M, C and B 210, 220, 230 and 240 and the image transfer heat medium 340 can be operated simultaneously. Therefore, for example, when the image for Y is recorded, simultaneously the image receiving layer transfer step is operated for obtaining the next image. There is no particular limitation on the motion of each of the steps.

The contents for the intermediate support described about the image recording apparatus comprising the intermediate support according to the present invention is applied to the image recording method using the intermediate support according to the present invention.

That is, an image recording method is preferable,
wherein the intermediate support comprises the substrate and the coating film, and
the coating film is formed by applying the composition for forming the coating film on at least one main surface of the substrate by using the spraying method.

Furthermore, an image recording method is preferable,
wherein the intermediate support comprises the substrate and the coating film, and
the coating film is formed by applying the composition for forming the coating film on at least one main surface of the substrate and then baking it at a temperature of not lower than 140° C. for a time of not shorter than 10 minutes.

An image recording method is preferable,
wherein such coating film is formed on the back surface of the intermediate support and the coating film contains the fluoro-resin as the solid lubricant.

Moreover, an image recording method is preferable,
wherein the coating film contains at least one selected from the polyimide based resin and the epoxy resin as the binder.

Furthermore, an image recording method is preferable,
wherein the substrate of the intermediate support has the thermal shrinkage of not more than 0.15% in each of directions parallel to and perpendicular to the longitudinal direction of the substrate of the intermediate support.

Further, an image recording method is preferable,
wherein the substrate of the intermediate support is in the form of the endless belt having the seam and there is substantially no coating film between the substrates of the connected part at the seam.

An image recording method is preferable,
wherein the substrate of the intermediate support is at least one kind of polymer film selected from the polyamide based polymer and the polyimide based polymer.

Moreover, in one embodiment of the image recording apparatus comprising the intermediate support according to the present invention, an image recording apparatus is preferable,
wherein the platen on which the image receiving layer transfer section is arranged comprises a heat medium for heating the platen.

Examples of such image recording apparatus contain the image recording apparatus as shown in FIGS. 2 and 3 wherein
the above described image receiving layer transfer head 130 and the ink-jet heads 210, 220, 230 and 240 are positioned on the one platen 420 and
the image receiving layer transfer head 130 and the ink-jet heads 210 are positioned on the one platen 430, and
the platen (420 or 430) on which the image receiving layer transfer section is arranged comprises the heat medium for heating the platen.

It is described above that there is one problem that the image receiving layer may transfer insufficiently to the image receiver in the image transfer section when the ink-jet head is used as the image recording means. The present inventors thought that this problem is caused by insufficient drying of the ink. They thought that the problem can be solved by accelerating drying of the ink and tried various researches. They have found one method for solving the problem wherein the image receiving layer transfer section and at least one of the ink-jet heads are positioned on the one same platen and further the heat medium is attached to the one platen, and completed the above image recording apparatus.

In the above image recording apparatus comprising the intermediate support, when the image receiving layer is transferred to the intermediate support, the platen is also heated by the image receiving layer transfer head. Consequently, when the first ink-jet image to be recorded (for example, yellow) after transfer of the image receiving layer is recorded on the same platen as the platen used on transferring the image receiving layer, drying of the first ink-jet image recorded can be accelerated by heat of the platen. However, in such apparatus, it is preferable that the platen on which the image transfer section is positioned is preferably appropriately heated by a heat medium attached to the platen so as to accelerate appropriately and surely drying of the ink-jet image. Examples of such platens on which the image receiving layer transfer section is arranged preferably contain a platen comprising a heat medium such as a heater inside thereof and a platen comprising a material heated by high-frequency heating. Further, FIGS. 2 and 3 do not show the heat medium for heating the platen which is attached to the platen (420 or 430) on which the image receiving layer transfer section is positioned. Considering the above described induction heating apparatus (1H heater), the platen preferably comprises the IH heater for the heat medium inside thereof as the platen on which the image receiving layer transfer section is positioned.

In addition, motions of the image recording apparatus comprising the heat medium for heating platen and the image recording method according to the motions are similar to the motions described above about the image recording apparatus shown in FIG. 1 and to the image recording method according to the motions, except that the image receiving layer transfer section and at least one of the ink-jet heads are positioned on the same platen and further drying of the ink-jet image is accelerated by using the heat medium for heating the platen which is attached to the platen on which the image receiving layer transfer section is positioned.

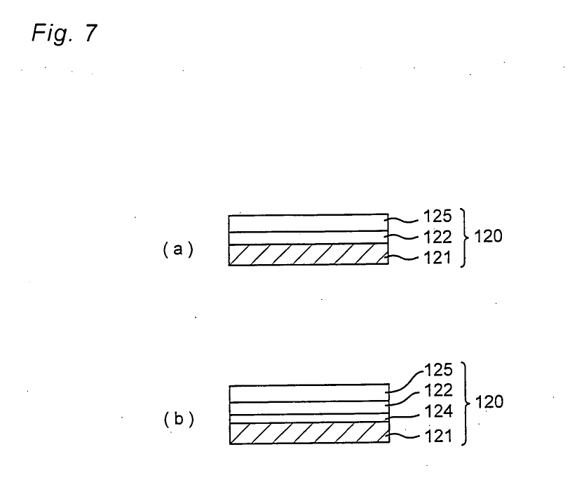

In another embodiment of the image recording apparatus comprising the intermediate support and the image recording method according to the present invention, an image recording apparatus and an image recording method are preferable,
wherein the image receiving layer transferer which includes the image receiving layer comprises a laminate in which the image receiving layer and an aqueous solvent permeating layer are laminated on the substrate for the image receiving layer transferer in the above listed order from the substrate. Such image receiving layer transferer 120 is exemplified in FIG. 7. In the image receiving layer transferer 120 shown in FIG. 7(a), the image receiving layer 122 is formed on the substrate 121 for the image receiving layer transferee, and the aqueous solvent permeating layer 125 is formed on the image receiving layer 122. In the image receiving layer transferer 120 shown in FIG. 7(b), a releasing layer 124 is formed between the image receiving layer 122 and the substrate 121 in respect to the image receiving layer transferer shown in FIG. 7(a).

When the image receiving layer transferer comprising the laminate in which the image receiving layer 122 and the aqueous solvent permeating layer 125 are laminated on the substrate 121 for the image receiving layer transferer in the above listed order from the substrate is used, the laminate is transferred to the intermediate support 410 in the image receiving layer transfer section 100. Consequently, the laminate changes to a laminate on the intermediate support wherein the aqueous solvent permeating layer 125 and the image receiving layer 122 are formed in this order from the intermediate support. That is, the order of the lamination in the laminate is inverted by transfer, so that the laminate changes to the laminate in which the aqueous solvent permeating layer 125 and the image receiving layer 122 are formed in this order from the intermediate support. Therefore, when an ink-jet recording is carried out on the laminate in the image recording section, an image is recorded in the image receiving layer and a liquid component in an ink can be easily absorbed by the aqueous solvent permeating layer under the image receiving layer, and the liquid component cannot be easily left on the surface of the image receiving layer. Therefore, the image receiving layer (that is, the laminate) can be easily adhered to the image receiver when the laminate is transferred in the image transfer section.

Further, the aqueous solvent permeating layer means that the liquid component in the ink for the ink-jet recording is permeated and absorbed and may usually be an aqueous solvent permeating layer used in a paper for the ink-jet recording. There is no particular limitation on the aqueous solvent permeating layer as far as the objective image recording apparatus and the image recording method are obtained. Such aqueous solvent permeating layer can be formed by using polymers having large polarity such as a particle-containing polymer and a cellulosic based polymer.

In a preferable embodiment of the image recording apparatus comprising the intermediate support according to the present invention, when the image recording section comprises the ink-jet head, the image recording section preferably comprises an image drying mechanism which accelerates drying of the image recorded in the image receiving layer.

Therefore, similarly in a preferable embodiment of the image recording method using the intermediate support according to the present invention, when the image is recorded in the image receiving layer by using the ink-jet head in the image recording section, the image recording section preferably comprises an image drying step in which drying of the image recorded in the image receiving layer is accelerated.

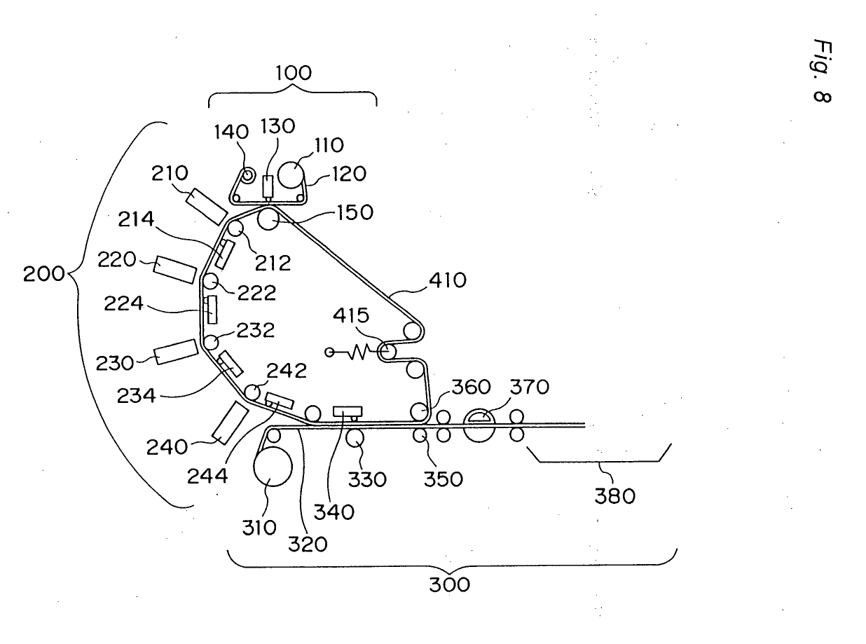

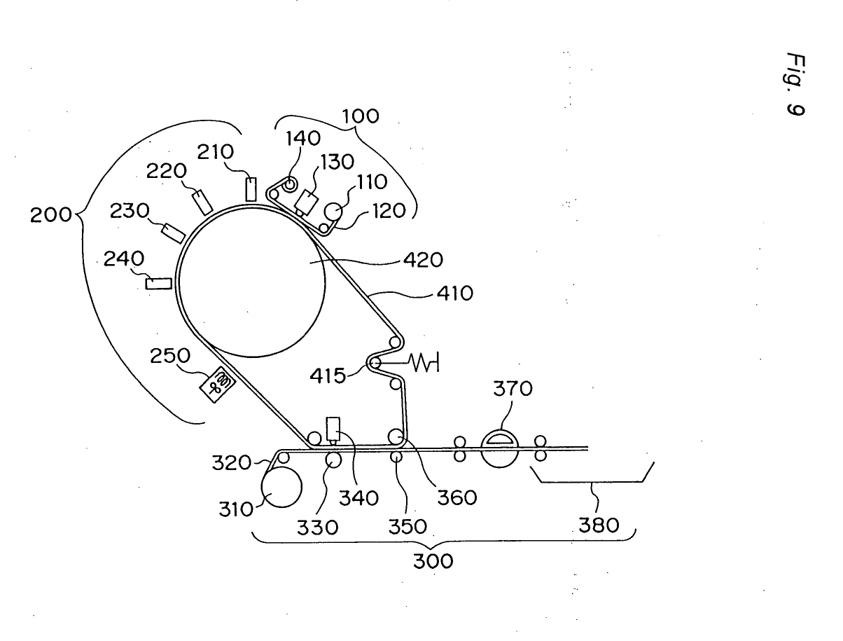

Preferable embodiments of the image recording apparatus comprising such image drying mechanism are demonstrated in FIGS. 8 and 9. Each of image drying mechanisms 214, 224, 234 and 244 are positioned at the downstream of each of the ink-jet heads 210, 220, 230 and 240 in the image recording apparatus shown in FIG. 8. This is an embodiment wherein after recording an image for one color, the image for the color is dried, respectively. In contrast, an image drying mechanism 250 such as a heat blower, a heater, a high-frequency heating, the induction heating apparatus (1H heater) etc. is positioned at the downstream of the ink-jet head 240 in the image recording apparatus shown in FIG. 9. This is an embodiment wherein after images for plurality of colors is recorded, the images for the colors are dried.

Drying may be carried out from the same surface as or the opposite surface to the surface of the intermediate support to which the image receiving layer is attached according to the image drying mechanism which is used. For example, the heat roller, the ceramic heater, the thermal head, the heat blower, the induction heating apparatus etc. can be used for the image drying mechanism.

When the image is appropriately dried by using the image drying mechanism, the image receiving layer can be easily attached to the image receiver. Even if the image receiving layer is in the form of the laminate, this situation is not changed. Furthermore, the induction heating apparatus is preferably used for the image drying mechanism due to the advantage of the IH heater.

Further, with respect to the image recording apparatus comprising the intermediate support according to the present invention, each of the above described embodiments can be used alone and a combination thereof can be used. For example, the intermediate support may comprise the substrate and the coating film, and the coating film may be formed by applying the composition for forming the coating film on at least one main surface of the substrate by means of the spraying method and by baking the composition at a temperature of not lower than 140° C. for a time of not shorter than 10 minutes. Further, for example, the platen on which the image receiving layer transfer section is positioned may comprises the heat medium for heating the platen and the image receiving layer transferer including the image receiving layer may comprise the laminate in which the image receiving layer and the aqueous solvent permeating layer are laminated on the substrate for the image receiving layer transferer in the above listed order from the substrate. Further, for example, the image receiving layer transferer including the image receiving layer may comprise the laminate in which the image receiving layer and the aqueous solvent permeating layer are laminated on the substrate for the image receiving layer transferer in the above listed order from the substrate and the image recording section may comprise the image drying mechanism so as to accelerate drying of the image recorded in the image receiving layer. All of these examples may be combined. Each of the embodiments can be combined each other in any manner.

With respect to the image recording method using the intermediate support according to the present invention, similarly, each of the embodiments can be used alone and a combination thereof can be used.

In addition, in respect to the image recording apparatus comprising the intermediate support and the image recording method using the intermediate support according to the present invention, the image receiver is preferably a cellulose paper wherein polyethylene is laminated on at least one main surface of the paper. Further, a RC paper and a photographic paper are preferable for the image receiver.

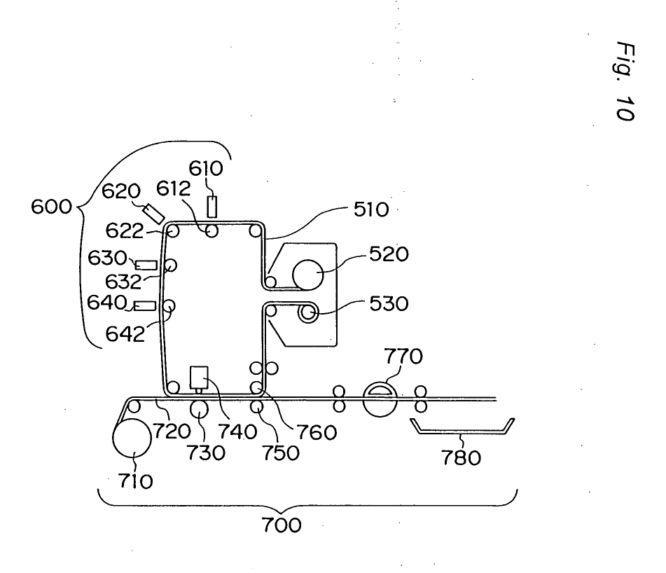

FIG. 10 demonstrates a schematic illustration of another embodiment of the image recording apparatus according to the present invention. This is an image recording apparatus comprising an image forming medium wherein an image recording section 600 and an image transfer section 700 are arranged counterclockwise along an image forming medium 510 in the listed order. The image forming medium 510 is rewound from a rewinding roll 520 for the image forming medium, extends over at least one platen (or roller), and is wound by a winding roll 530. The image recording section 600 comprises ink-jet heads for three primary colors (yellow (Y), magenta (M), cyan (C)) and for black (B) 610, 620, 630, 640 and platens 612, 622, 632, 642. The image transfer section 700 comprises a rewinding roll 710 for an image receiver, an image receiver 720, a platen 730, an image transfer heat medium 740, rollers 750 and 760, a cutter 770 and a tray 780.

Examples of the image transfer heat medium 740 contains the thermal head, the heat roller, the ceramic heater, the heat blower, the induction heating apparatus etc. The thermal head is preferable. The induction heating apparatus is also preferable according to its advantage. The image forming medium 510 including an image receiving layer preferably comprises a laminate of an aqueous solvent permeating layer and the image receiving layer which are laminated on a substrate for the image forming medium in the above listed order from the substrate.

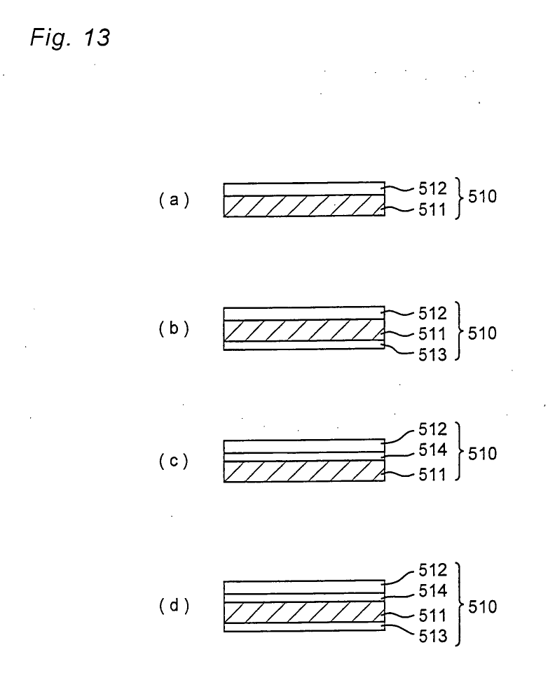

FIG. 13 shows schematic illustrations of cross-sectional views along directions perpendicular to longitudinal directions of various image forming mediums 510 comprising the image receiving layer. FIG. 13(a) shows an image forming medium in which an image receiving layer 512 is formed on a substrate 511 for the image forming medium. FIG. 13(b) shows an image forming medium in which a heat-resistant sliding layer 513 is formed under the substrate 511 for the image forming medium of FIG. 13(a). FIG. 13(c) shows an image forming medium in which a releasing layer 514 is formed between the image receiving layer 512 and the substrate 511 for the image forming medium of FIG. 13(a). FIG. 13(d) shows an image forming medium in which the heat-resistant sliding layer 513 is formed under the substrate for the image forming medium of FIG. 13(c).

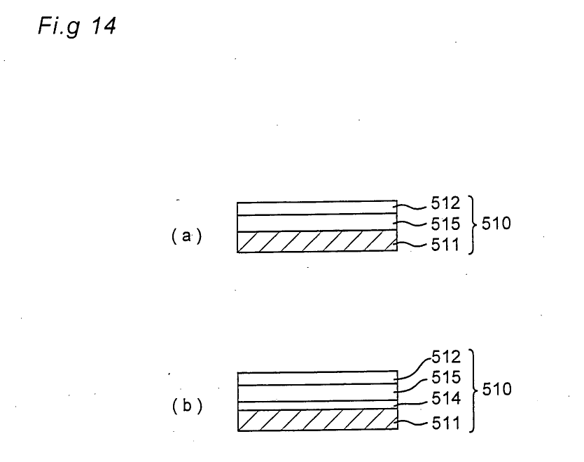

FIG. 14 shows a cross-sectional view along a direction perpendicular to a longitudinal direction of the image forming medium 510 comprising a laminate of an aqueous solvent permeating layer and the image receiving layer which are laminated on and in the above listed order from the substrate for the image forming medium. FIG. 14(a) shows an image forming medium in which the aqueous solvent permeating layer 515 is formed between the image receiving layer 512 and the substrate 511. FIG. 14(b) shows an image forming medium in which the releasing layer 514 is formed between the aqueous solvent permeating layer 515 and the substrate 511 for the image forming medium of FIG. 14(a).

With respect to any of the image forming mediums, the image receiving layer is formed on the surface of the image forming medium and an image is recorded in the image receiving layer. In addition, the substrate, the image receiving layer, the heat-resistant sliding layer, the releasing layer and the aqueous solvent permeating layer for the image forming medium are similar to those for the image receiving layer transferer which is employed in the image recording apparatus using the intermediate support.

Hereinafter, motions of the image recording apparatus comprising the image forming medium shown in FIG. 10 will be explained and an image recording method using the image forming medium according to the present invention will be also explained based on the motions.

The image forming medium 510 is rewound from the rewinding roll 520 and sent to the image recording section 600. In the image recording section 600, an image for yellow is recorded by the ink-jet head for Y 610 in the image receiving layer 512 of the image forming medium. Then, each of images for M, C and B is recorded by each of the ink-jet head for M 620, the ink-jet head for C 630 and the ink-jet head for B 640. The image forming medium in which the image is recorded is sent to the image transfer section 700 and then an image recording step is completed.

In the image transfer section 700, the image forming medium is passed between the image transfer heat medium 740 and the platen 730 while keeping the image forming medium laid on the image receiver 720. The image receiving layer on which the image is recorded is transferred to the image receiver 720 from the image forming medium 510. The image receiver 720 comprising the transferred image receiving layer is cut in the front and rear of the image (optionally, in the right side and left side of the image), and then the cut image is obtained in the tray 780 and an image transfer step is completed. The image forming medium 510 which has finished the image recording in the image transfer section 700 is wound by the winding roll 530.

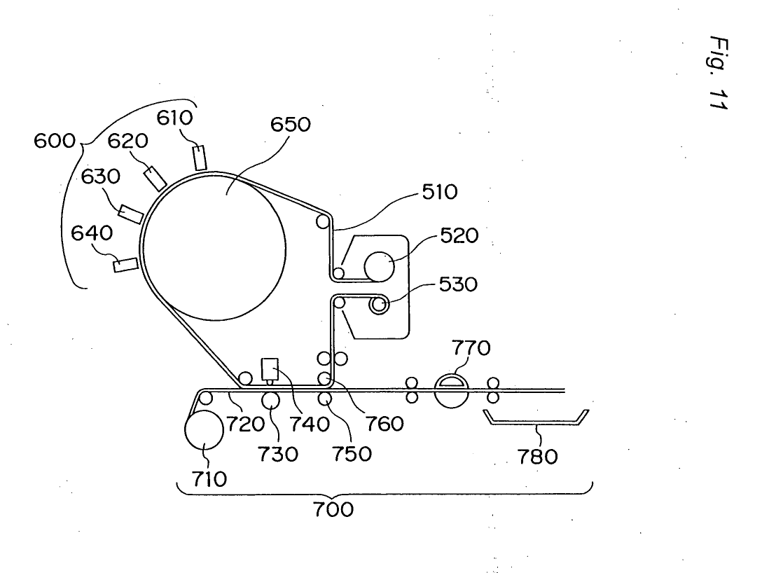

FIG. 11 shows a schematic illustration of another embodiment of the image recording apparatus comprising the image forming medium according to the present invention. This is an embodiment in which all of the ink-jet heads are positioned on the same platen 650. Compared with the image recording apparatus comprising the image forming medium shown in FIG. 10, this image recording apparatus is similar to the image recording apparatus shown in FIG. 10, except that arrangements of the ink-jet heads and the platens of this apparatus are different from those of the apparatus shown in FIG. 10. There are no particular limitations on the arrangements of the ink-jet heads and the platens with respect to the image recording apparatus comprising the image forming medium according to the present invention.

With respect to the image recording apparatus comprising the image forming medium and the image recording method using the image forming medium according to the present invention, the image forming medium including the laminate in which the aqueous solvent permeating layer and the image receiving layer are laminated on the substrate for the image forming medium in the above listed order from the substrate is preferably used, since the liquid component of the ink is absorbed by the aqueous solvent permeating layer and drying of the image recorded in the image receiving layer is accelerated when the ink-jet recording is carried out.

Further, when the image forming medium wherein the aqueous solvent permeating layer and the image receiving layer are laminated on the substrate for the image forming medium in the above order from the substrate is used in the above image recording apparatus comprising the image forming medium according to the present invention for the image forming medium comprising the image receiving layer, the image receiver 720 has a laminate in the image transfer section 700 wherein the image receiving layer 512 and the aqueous solvent permeating layer 515 are laminated in this listed order from the image receiver 720.

The above image recording apparatus comprising the image forming medium according to the present invention preferably comprises the image recording section including an image drying mechanism which accelerates drying of the image recorded in the image receiving layer of the image forming medium. The image recording method using the above image forming medium preferably comprises an image drying step in which drying of the image recorded on the image receiving layer is accelerated in the image recording section after recording the image in the image receiving layer of the image forming medium by using the ink-jet head,

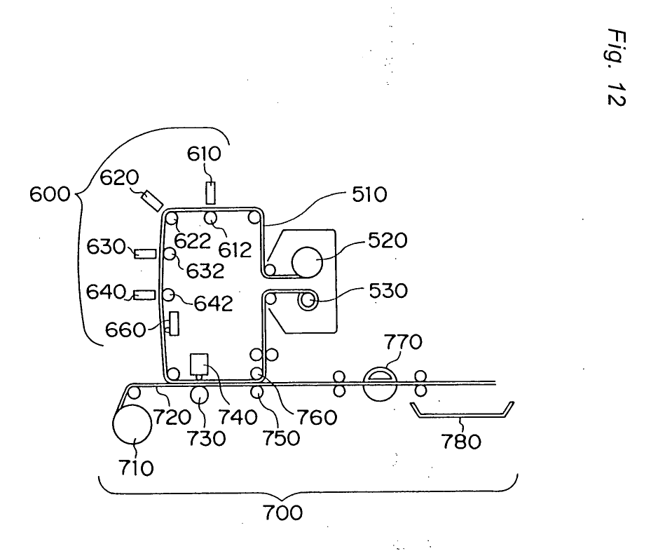

FIG. 12 shows a preferable embodiment of the image recording apparatus comprising the image forming medium wherein the image recording apparatus comprises the image drying mechanism which accelerates drying of the image. The image drying mechanism 660 is placed in the down stream of the ink-jet head 640 in the image recording apparatus shown in FIG. 12. This is an embodiment wherein an image is dried compulsorily after recording images for a plurality of colors. As the image recording apparatus in FIG. 8, each of image drying mechanisms may be placed in the down stream of each of the ink-jet heads. That is, after recording an image for every one color, the image may be forced to be dried compulsorily.

The above compulsory drying of the image may be carried out from a surface of the image receiving layer of the image forming medium or from a surface opposite to the image receiving layer. For example, the heat roller, the ceramic heater, the thermal head, the heat blower and the induction heating apparatus etc. can be used for such image drying mechanism.

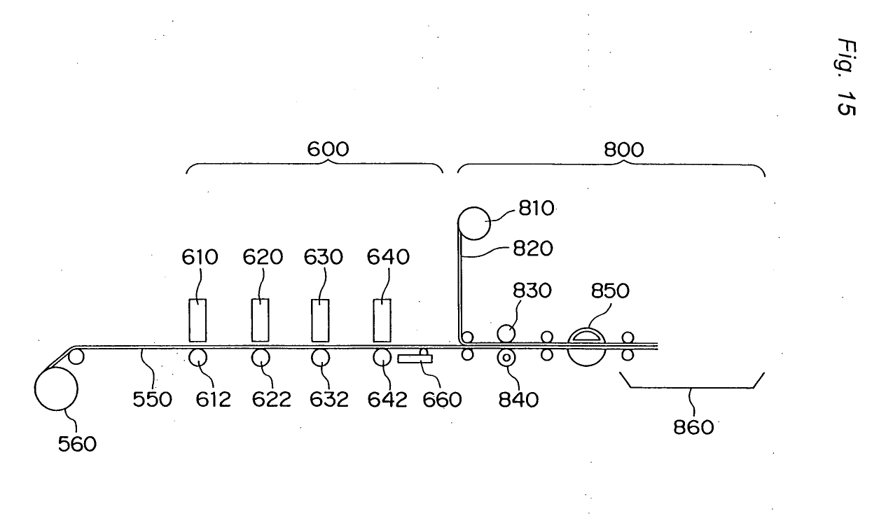

FIG. 15 shows a schematic illustration of another embodiment of the image recording apparatus comprising the image forming medium according to the present invention. This is an embodiment of the image recording apparatus which comprises an image incorporating section for integrating the image receiver with the image forming medium in which the image is recorded on the image receiving layer. The image recording section 600 and an image incorporating section 800 are positioned along an image forming medium 550 in the order. The image forming medium 550 is rewound from the rewinding roll 560 for the image forming medium and extends over at least one platen (or roller). The image recording section 600 comprises the ink-jet heads for three primary colors (yellow (Y), magenta (M), cyan (C)) and for black (B) 610, 620, 630, 640 and the platens 612, 622, 632, 642, and further comprises the image drying mechanism 660. The image incorporating section 800 is placed adjacent to the image recording section 600 and comprises a rewinding roll for an image receiver 810, the image receiver 820, a roller covered by rubber (or a roller) 830, an image incorporating heat medium 840, a cutter 850 and a tray 860.

For example, the heat roller, the ceramic heater, the thermal head, the heat blower and the induction heating apparatus etc. can be used for the image drying mechanism 660.

Examples of the image incorporating heat medium contains the heat roller, the ceramic heater, the thermal head, the heat blower and the induction heating apparatus etc. The thermal head is preferable. Furthermore, the induction heating apparatus is also preferable.

Structure of the image forming medium 550 is the same as that of the described image forming medium 510 comprising the image receiving layer. The image receiving layer is formed on the surface of the image forming medium, and an image is recorded on the image receiving layer. The image forming medium 550 may comprise an aqueous solvent permeating layer. A substrate, the image receiving layer, a heat-resistant sliding layer, a releasing layer and the aqueous solvent permeating layer for the image forming medium 550 are similar to those for the image receiving layer transferer used in the image recording apparatus comprising the intermediate support. However, it is necessary for the substrate (and the aqueous solvent permeating layer if it is formed) to be transparent. The image forming medium 550 also preferably comprises a laminate in which the aqueous solvent permeating layer and the image receiving layer are laminated on the substrate for the image forming medium in this listed order from the substrate. In addition, the image forming medium 550 is different from the image forming medium 510 and does not preferably comprise the releasing layer.

Hereinafter motions of the image recording apparatus comprising the image forming medium and the image incorporating section shown in FIG. 15 will be explained and an image recording method using the image forming medium and comprising an image incorporating step will be also explained according to the motions.

The image forming medium 550 is rewound from the rewinding roll 560 for the image forming medium and sent to the image recording section 600. A yellow image is recorded by the ink-jet head for Y 610 on the image receiving layer of the image forming medium (the image receiving layer is not shown in FIG. 15) in the image recording section 600. After each of images for M, C, B is recorded by each of the ink-jet head for M 620, the ink-jet head for C 630 and the ink-jet head for B 640, the image is dried compulsorily by the image drying mechanism 660. The image forming medium is sent to the image incorporating section 800 and an image recording step is completed.

The image forming medium comprising the laminate of the aqueous solvent permeating layer and the image receiving layer which are laminated on the substrate for the image forming medium in this listed order from the substrate is preferably used, since the liquid component of the ink is absorbed by the aqueous solvent permeating layer when the ink-jet recording is carried out.

The image receiving layer recorded is laid on the image receiver 820 and passed between the image incorporating heat medium 840 and the roller 830 covered by rubber, so that the image forming medium 550 is integrated with the image receiver 820. The image receiver 820 integrated with the image forming medium 550 is optionally cut in the front and rear of the image (further optionally in the right side and the left side of the image) by the cutter 870. The cut image is obtained in the tray 860 and the image incorporation step is completed.

The image recording apparatus including the image forming medium and the image incorporating section preferably comprises the image recording section which comprises the image drying mechanism so as to accelerate drying of the image recorded on the image receiving layer of the image forming medium as shown in FIG. 15. Therefore, the image recording method using the image forming medium and comprising the image incorporating step preferably comprises the image drying step in which drying of the image recorded on the image receiving layer is accelerated.

In addition, all of the ink-jet heads of the apparatus shown in FIG. 15 may be placed on the same one platen as the apparatus shown in FIG. 11 and there is no particular limitation on the number of the platen and arrangement of the ink-jet heads etc.

In respect to the image recording apparatus comprising the image forming medium and the image recording method using the image forming medium according to the present invention, the image receiver preferably comprises the cellulose paper of which at least one main surface is laminated with a polyethylene. Further, the RC paper and the photographic paper are preferable for the image receiver.

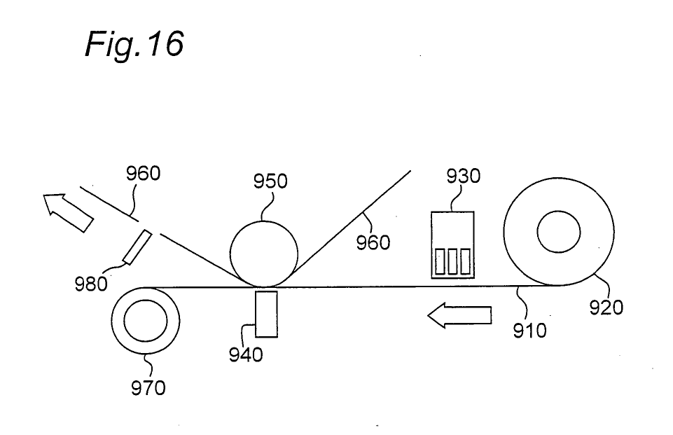

FIG. 16 shows a schematic illustration of a preferable embodiment of the image transfer section for the image recording apparatus (shown in FIGS. 10-12) comprising the image forming medium. An image forming medium 910 is rewound from a rewinding roll 920 for the image forming medium, extends over at least one platen (or roller, for example, a platen 950 in FIG. 16), and is wound by a winding roll 970 for the image forming medium. An image transfer section in FIG. 16 comprises a rewinding roll for an image receiver (not shown), an image receiver 960, the platen 950, an image transfer heat medium 940, a cutter 980 and a tray (not shown).

Parts other than the image transfer section are omitted rough in FIG. 16. However, an ink-jet head 930 for an image recording section is exemplified. The ink-jet head 930 is a line ink-jet head comprising three primary colors (yellow (Y), magenta (M), cyan (C)), further may be a line ink-jet head comprising black (B) optionally. Furthermore, the ink-jet head 930 may be a combination of each of the ink-jet heads for the three colors (that is, three kinds of ink-jet heads) as shown in the above image recording apparatus and further may be a combination of the ink-jet head for black optionally. The above described image recording sections may be selected.

The image forming medium is previously laid on the image receiver, the image forming medium and the image receiver are passed between the platen and the image transfer heat medium, so that the image is transferred to the image receiver, and then the image forming medium is released from the image receiver in the image transfer section exemplified in FIGS. 10-12. Therefore, the image transfer section shown in FIGS. 10-12 comprises three kinds of platens wherein one of the platens is used for laying the image forming medium on the image receiver, once of the platens is used for transferring the image to the image receiver, and one of the platens is used for releasing the image forming medium from the image receiver.

In contrast, laying the image forming medium 910 on the image receiver 960, passing the image forming medium 910 and the image receiver 960 between the platen 950 and the image transfer heat medium 940 so as to transfer the image, and releasing the image forming medium from the image receiver are carried out by using only one platen in the image transfer section shown in FIG. 16. The image transfer section shown in FIG. 16 is different from the image transfer section shown in FIG. 10-12 in this point. That is, the platen for previously laying the image forming medium on the image receiver and the platen for releasing the image forming medium from the image receiver are not necessary in the image transfer section shown in FIG. 16. Therefore, the image transfer section shown in FIG. 16 more preferably has advantages in that its structure can be simplified and more compacted since number of the platens is reduced, and is more preferable.

In addition, the image forming medium 910, the image transfer heat medium 940 and the image receiver 960 etc. may be the above described image forming medium, the image transfer heat medium and the image receiver etc.

Any one of the image transfer heat medium, the image incorporating heat medium, the heat medium for heating the platen and the image drying mechanism is preferably the induction heating apparatus in the above image recording apparatus according to the present invention (in both the apparatus comprising the intermediate support and the apparatus comprising the image forming medium).

Any one of the image transfer heat medium, the image incorporating heat medium, the heat medium for heating platen and a material (more concretely the image drying mechanism) used for accelerating drying of the image in the image drying step is preferably the induction heating apparatus in the above image recording methods according to the present invention (in both the method using the intermediate support and the method using the image forming medium).

1. An image recording apparatus comprising:
an image forming medium which extends over at least one platen and comprises an image receiving layer,
an image recording section having at least one ink-jet head which faces the image receiving layer of the image forming medium on an outer periphery of one platen of said at least one platen, and
an image transfer section having
an image receiver and
an image transfer heat medium which faces the image forming medium in its back side,
wherein the image forming medium comprises a laminate of an aqueous solvent permeating layer and the image receiving layer which are laminated on and in the above listed order from a substrate for the image forming medium.

2. An image recording apparatus comprising:
an image forming medium which extends over at least one platen and comprises an image receiving layer,
an image recording section having at least one ink-jet head which faces the image receiving layer of the image forming medium on an outer periphery of one platen of said at least one platen, and
an image transfer section having
an image receiver and
an image transfer heat medium which faces the image forming medium in its back side,
wherein the image recording section comprises an image drying mechanism which accelerates drying of an image recorded on the image receiving layer of the image forming medium.

3. An image forming medium comprising a laminate wherein an aqueous solvent permeating layer and an image receiving layer are laminated on a substrate for the image forming medium in the above listed order from the substrate.

4. An image recording apparatus comprising:
an image forming medium which extends over at least one platen and comprises an image receiving layer,
an image recording section having
at least one ink-jet head which faces the image receiving layer of the image forming medium on an outer periphery of one platen of said at least one platen and
an image drying mechanism which accelerates drying of an image recorded on the image receiving layer of the image forming medium, and
an image incorporating section having
an image receiver and
an image incorporating heat medium for integrating the image forming medium with the image receiver which faces the image forming medium in its back side.

5. An image recording apparatus comprising:
an intermediate support which forms a closed loop and extends over at least one platen,
an image receiving layer transfer section having
an image receiving layer transferer which includes an image receiving layer and
an image receiving layer transfer head which faces a part of the intermediate support on an outer periphery of one platen of said at least one platen,
an image recording section having at least one ink-jet head or toner-jet head which faces a part of the intermediate support on an outer periphery of one platen which is the same as or different from said one platen, and
an image transfer section having
an image receiver and
an image transfer heat medium which faces the intermediate support inside the closed loop,
wherein the intermediate support comprises a substrate and a coating film, and
the coating film is formed by applying a coating composition for forming the coating film on at least one main surface of the substrate by using a spraying method.

6. An image recording apparatus comprising:
an intermediate support which forms a closed loop and extends over at least one platen,
an image receiving layer transfer section having
an image receiving layer transferer which includes an image receiving layer and
an image receiving layer transfer head which faces a part of the intermediate support on an outer periphery of one platen of said at least one platen,
an image recording section having at least one ink-jet head or toner-jet head which faces a part of the intermediate support on an outer periphery of one platen which is the same as or different from said one platen, and
an image transfer section having
an image receiver and
an image transfer heat medium which faces the intermediate support inside the closed loop,
wherein the intermediate support comprises a substrate and a coating film, and
the coating film is formed by applying a coating composition for forming the coating film on at least one main surface of the substrate and then baking it at a temperature of not lower than 140° C. for a time of not shorter than 10 minutes.

7. The image recording apparatus according to claim 5 characterized in that the coating film of the intermediate support is formed on its back surface and the coating film contains a fluoro-resin as a solid lubricant.

8. The image recording apparatus according to claim 5 characterized in that the coating film of the intermediate support contains at least one selected from a polyimide based resin and an epoxy resin as a binder.

9. The image recording apparatus according to claim 5 characterized in that the substrate of the intermediate support has a thermal shrinkage of not more than 0.15% in each of directions parallel to and perpendicular to the longitudinal direction of the substrate of the intermediate support.

10. The image recording apparatus according to claim 5 characterized in that the substrate of the intermediate support is in the form of an endless belt having a seam and there is substantially no coating film between the substrates of connected parts at the seam.

11. The image recording apparatus according to claim 5 characterized in that the substrate of the intermediate support comprises at least one kind of polymer film selected from a polyamide based polymer and a polyimide based polymer.

12. An image recording apparatus comprising:
an intermediate support which forms a closed loop and extends over at least one platen,
an image receiving layer transfer section having
an image receiving layer transferer which includes an image receiving layer and
an image receiving layer transfer head which faces a part of the intermediate support on an outer periphery of one platen of said at least one platen,
an image recording section having at least one ink-jet head which faces a part of the intermediate support on an outer periphery of one platen which is the same as said one platen, and
an image transfer section having
an image receiver and
an image transfer heat medium which faces the intermediate support inside the closed loop,
wherein the platen on which the image receiving layer transfer section is positioned comprises a heat medium for heating the platen.

13. An image recording apparatus comprising:
an intermediate support which forms a closed loop and extends over at least one platen,
an image receiving layer transfer section having
an image receiving layer transferer which includes an image receiving layer and
an image receiving layer transfer head which faces a part of the intermediate support on an outer periphery of one platen of said at least one platen,
an image recording section having at least one ink-jet head which faces a part of the intermediate support on an outer periphery of one platen which is the same as or different from said one platen, and
an image transfer section having
an image receiver and
an image transfer heat medium which faces the intermediate support inside the closed loop,
wherein the image receiving layer transferer including the image receiving layer comprises a laminate of the image receiving layer and an aqueous solvent permeating layer which are laminated on and in the above listed order from a substrate for the image receiving layer transferee.

14. An image recording apparatus comprising:
an intermediate support which forms a closed loop and extends over at least one platen,
an image receiving layer transfer section having
an image receiving layer transferer which includes an image receiving layer and
an image receiving layer transfer head which faces a part of the intermediate support on an outer periphery of one platen of said at least one platen,
an image recording section having at least one ink-jet head which faces a part of the intermediate support on an outer periphery of one platen which is the same as or different from said one platen, and
an image transfer section having
an image receiver and
an image transfer heat medium which faces the intermediate support inside the closed loop,
wherein the image recording section comprises an image drying mechanism which accelerates drying of an image recorded on the image receiving layer.

15. An image receiving layer transferer which includes an image receiving layer comprises a laminate wherein the image receiving layer and an aqueous solvent permeating layer are laminated on a substrate for the image receiving layer transferer in the above listed order from the substrate.

16. The image recording apparatus according to claim 1 characterized in that the image receiver comprises cellulose paper of which at least one main surface is laminated with a polyethylene.

17. An image recording method using:
an image forming medium which extends over at least one platen and includes a laminate in which an aqueous solvent permeating layer and an image receiving layer are laminated on and in the above listed order from a substrate for the image forming medium,
an ink-jet head for recording an image on the image receiving layer,
an image receiver, and
an image transfer heat medium for thermally transferring the laminate in which the image is recorded on the image receiving layer from the image forming medium to the image receiver,
wherein the image recording method comprises:
an image recording step in which the image is recorded on the image receiving layer of the laminate on the image forming medium by using the ink-jet head in an image recording section, and
an image transfer step in which the image forming medium is heated from its back surface by using the image transfer heat medium and then the laminate in which the image is recorded is transferred to the image receiver in an image transfer section.

18. An image recording method using:
an image forming medium which extends over at least one platen and includes an image receiving layer,
an ink-jet head for recording an image on the image receiving layer,
an image receiver, and
an image transfer heat medium for thermally transferring the image receiving layer in which the image is recorded from the image forming medium to the image receiver,
wherein the image recording method comprises:
an image recording step in which the image is recorded on the image receiving layer of the image forming medium by using the ink-jet head and an image drying step in which drying of the recorded image on the image receiving layer is accelerated in an image recording section, and
an image transfer step in which the image forming medium is heated from its back surface by using the image transfer heat medium and then the image receiving layer having the image recorded thereon is transferred to the image receiver in an image transfer section.

19. An image recording method using:
an image forming medium which extends over at least one platen and includes an image receiving layer,
an ink-jet head for recording an image on the image receiving layer,
an image receiver, and
an image incorporating heat medium for integrating the image receiver with the image forming medium in which an image is recorded on the image receiving layer,
wherein the image recording method comprises:
an image recording step in which the image is recorded on the image receiving layer of the image forming medium using the ink-jet head and an image drying step in which drying of the recorded image of the image receiving layer is accelerated in an image recording section, and
an image incorporating step in which the image forming medium is heated from its back surface by using the image incorporating heat medium, so that the image forming medium comprising the image receiving layer on which the image is recorded is integrated with the image receiver in an image incorporating section.

20. An image recording method using:
an intermediate support which forms a closed loop while it extends over at least one platen,
an image receiving layer transferer including an image receiving layer,
an image receiving layer transfer head for thermally transferring the image receiving layer to the intermediate support,
at least one ink-jet head or toner-jet head for recording an image on the image receiving layer,
an image receiver, and
an image transfer heat medium for transferring the image receiving layer on which the image is recorded from the intermediate support to the image receiver,
wherein the image recording method comprises:
an image receiving layer transfer step in which the image receiving layer transferer is heated from its back surface, so that the image receiving layer is thermally transferred to the intermediate support in an image receiving layer transfer section,
an image recording step in which the image is recorded on the image receiving layer of the intermediate support by using the ink-jet head or toner-jet head, and the image receiving layer transfer head and said at least one ink-jet head or toner-jet head face a part of the intermediate support on an outer periphery of a platen which is the same as or different from the platen which they face in an image recording section, and
an image transfer step in which the intermediate support is heated from its back surface by using the image transfer heat medium, so that the image receiving layer on which the image is recorded is transferred to the image receiver in an image transfer section, and
the intermediate support comprises a substrate and a coating film, and
the coating film is formed by applying a coating composition for forming the coating film on at least one main surface of the substrate by using a spraying method.

21. An image recording method using:
an intermediate support which forms a closed loop while it extends over at least one platen,
an image receiving layer transferer including an image receiving layer,
an image receiving layer transfer head for thermally transferring the image receiving layer to the intermediate support,
at least one ink-jet head or toner-jet head for recording an image on the image receiving layer,
an image receiver, and
an image transfer heat medium for transferring the image receiving layer on which the image is recorded from the intermediate support to the image receiver,
wherein the image recording method comprises:
an image receiving layer transfer step in which the image receiving layer transferer is heated from its back surface, so that the image receiving layer is thermally transferred to the intermediate support in an image receiving layer transfer section,
an image recording step in which the image is recorded on the image receiving layer of the intermediate support by using the ink-jet head or toner-jet head, and the image receiving layer transfer head and said at least one ink-jet head or toner-jet head face a part of the intermediate support on an outer periphery of a platen which is the same as or different from the platen which they face in an image recording section, and
an image transfer step in which the intermediate support is heated from its back surface by using the image transfer heat medium, so that the image receiving layer on which the image is recorded is transferred to the image receiver in an image transfer section, and
the intermediate support comprises a substrate and a coating film, and
the coating film is formed by applying a coating composition for forming the coating film on at least one main surface of the substrate and then baking it at a temperature of not lower than 140° C. for a time of not shorter than 10 minutes.

22. The image recording method according to claim 20 characterized in that the coating film of the intermediate support is formed on its back surface and the coating film contains a fluoro-resin as a solid lubricant.

23. An image recording method using:
an intermediate support which forms a closed loop while it extends over at least one platen,
an image receiving layer transferer including an image receiving layer,
an image receiving layer transfer head for thermally transferring the image receiving layer to the intermediate support,
at least one ink-jet head for recording an image on the image receiving layer,
an image receiver, and
an image transfer heat medium for transferring the image receiving layer on which the image is recorded from the intermediate support to the image receiver,
wherein the image recording method comprises:
an image receiving layer transfer step in which the image receiving layer transferer is heated from its back surface, so that the image receiving layer is thermally transferred to the intermediate support in an image receiving layer transfer section,
an image recording step in which the image is recorded on the image receiving layer of the intermediate support by using the ink-jet head, and the image receiving layer transfer head and said at least one ink-jet head face a part of the intermediate support on an outer periphery of a platen which is the same as the platen which they face in an image recording section, and
an image transfer step in which the intermediate support is heated from its back surface by using the image transfer heat medium, and the image receiving layer on which the image is recorded is transferred to the image receiver in an image transfer section, and
the platen on which the image receiving layer transfer section is positioned comprises a heat medium for heating the platen.

24. An image recording method using:
an intermediate support which forms a closed loop while it extends over at least one platen,
an image receiving layer transferer comprising an image receiving layer,
an image receiving layer transfer head for thermally transferring the image receiving layer to the intermediate support,
at least one ink-jet head for recording an image on the image receiving layer,
an image receiver, and
an image transfer heat medium for transferring the image receiving layer on which the image is recorded from the intermediate support to the image receiver,
wherein the image receiving layer transferer which includes the image receiving layer comprises a laminate in which the image receiving layer and an aqueous solvent permeating layer are laminated on and in the above listed order from a substrate for the image receiving layer transferee, and
the image recording method comprises:
an image receiving layer transfer step in which the image receiving layer transferer is heated from its back surface, so that the image receiving layer is thermally transferred to the intermediate support in an image receiving layer transfer section,
an image recording step in which the image is recorded on the image receiving layer of the intermediate support by using the ink-jet head, and the image receiving layer transfer head and said at least one ink-jet head face a part of the intermediate support on an outer periphery of a platen which is the same as or different from the platen which they face in an image recording section, and
an image transfer step in which the intermediate support is heated from its back surface by using the image transfer heat medium, so that the laminate which has the image recorded is transferred to the image receiver in an image transfer section.

25. An image recording method using:
an intermediate support which forms a closed loop while it extends over at least one platen,
an image receiving layer transferer including an image receiving layer,
an image receiving layer transfer head for thermally transferring the image receiving layer to the intermediate support,
at least one ink-jet head for recording an image on the image receiving layer,
an image receiver, and
an image transfer heat medium for transferring the image receiving layer on which the image is recorded from the intermediate support to the image receiver,
wherein the image recording method comprises:
an image receiving layer transfer step in which the image receiving layer transferer is heated from its back surface, so that the image receiving layer is thermally transferred to the intermediate support in an image receiving layer transfer section,
an image recording step in which the image is recorded in the image receiving layer of the intermediate support by using the ink-jet head, and the image receiving layer transfer head and said at least one ink-jet head face a part of the intermediate support on an outer periphery of a platen which is the same as or different from the platen which they face in an image recording section, and
an image transfer step in which the intermediate support is heated from its back surface by using the image transfer heat medium, so that the image receiving layer on which the image is recorded is transferred to the image receiver in an image transfer section, and
the image recording section comprises an image drying mechanism which accelerates drying of the recorded image on the image receiving layer.

26. The image recording method according to claim 17 characterized in that the image receiver comprises cellulose paper of which at least one main surface is laminated with a polyethylene.
